(19) United States
(12) Patent Application Publication
(10) Pub. No.: US 2019/0291092 A1
(43) Pub. Date: Sep. 26, 2019

(54) Core-Shell Nanoparticulate Compositions And Methods

(71) Applicant: The Trustees of the University of Pennsylvania, Philadelphia, PA (US)

(72) Inventors: Matteo Cargnello, Pocenia UD (IT); Raymond J. Gorte, Narberth, PA (US); Paolo Fornasiero, Trieste TS (IT)

(21) Appl. No.: 16/255,552

(22) Filed: Jan. 23, 2019

Related U.S. Application Data
(63) Continuation of application No. 14/045,000, filed on Oct. 3, 2013, now abandoned.
(60) Provisional application No. 61/712,681, filed on Oct. 11, 2012.

(51) Int. Cl. B01J 37/00; H01M 4/86; B01J 37/16; B01J 23/42; B01J 23/63; B01J 23/60; B01J 35/08; B01J 35/00; B01J 23/755; B01J 23/75; B01J 23/72; B01J 23/52; B01J 23/50; B01J 23/46; B01J 21/06; B01J 23/44

(52) U.S. Cl. CPC B01J 37/0072; B01J 23/44; B01J 37/16; B01J 23/42; B01J 23/63; B01J 23/60; B01J 35/08; B01J 35/0086; B01J 35/008; B01J 35/004; B01J 35/0013; B01J 23/755; B01J 23/75; B01J 23/72; B01J 23/52; B01J 23/50; B01J 23/468; B01J 23/464; B01J 23/462; B01J 21/066; B01J 21/063; H01M 4/8657

(57) ABSTRACT

Core-shell nanoparticulate compositions and methods for making the same are disclosed. In some embodiments core-shell nanoparticulate compositions comprise transition metal core encapsulated by metal oxide shell. Methods of catalysis comprising core-shell nanoparticulate compositions of the invention are disclosed. Compositions comprising core-shell nanoparticles displayed on a metal-oxide support and methods for preparing the same are also disclosed. In some embodiments compositions comprise core-shell nanoparticles displayed as a substantially single layer superposed on a metal oxide support. Methods of catalysis employing the supported core-shell nanoparticles are disclosed.

### CROSS REFERENCE TO RELATED APPLICATIONS

This application is a continuation of U.S. patent application Ser. No. 14/045,000, filed Oct. 3, 2013, which claims priority to U.S. Provisional Patent Application No. 61/712,681, filed Oct. 11, 2012, the contents of which are incorporated by reference in their entirety for all purposes.

### GOVERNMENT RIGHTS

This invention was made with government support under Grant No. FA9550-08-1-0309 awarded by the Air Force Office of Scientific Research (Multidisciplinary Research Program of the University Research Initiative). The government has certain rights in the invention.

### TECHNICAL FIELD

The present invention relates catalytic materials and core-shell nanoparticles, core-shell nanoparticles superposed on metal oxide support, and methods for making the same.

### BACKGROUND

Methane (CH₄) is the largest constituent of natural gas and is widely employed in power generation and in other heating applications. However, the release of unburned CH₄ during homogeneous combustion is a serious problem, given that CH₄ is a greenhouse gas with an effect that is 20 times higher than that of CO₂. Presently available, emissions-control catalysts are notoriously ineffective at reducing concentrations of CH₄ in exhaust streams. High-temperature combustion also results in the emission of toxic nitrogen oxides (NOₓ) and CO.

Given the high stability of CH₄, heterogeneous catalysts for methane oxidation must be very active at low reaction temperatures (preferably below 400° C.). Furthermore, materials for this application must also be catalytically and mechanically stable at high reaction and flame temperatures. PdOₓ supported on alumina or zirconia is recognized as one of the best catalysts for catalytic CH₄ oxidation, even if the active phase of the catalysts is still disputed. Unfortunately, Pd-based catalysts tend to deactivate through loss of active surface by sintering and by transformation into metallic Pd at temperatures above 600° C. Both experimental and theoretical studies reveal that ceria (CeO₂) can improve the catalytic activity of supported Pd by stabilizing PdOₓ, but pure CeO₂ has limited thermal stability. Other systems based on metal oxides have been studied, but their activity is generally much lower, with complete CH₄ conversion obtained only above 600° C. Materials that could simultaneously enhance the performance of Pd-based catalysts at low temperatures and limit deactivation at elevated temperatures would greatly improve various catalytic processes, including hydrocarbon combustion processes.

### SUMMARY

Some embodiments of the invention provide for core-shell nanoparticulate compositions, each composition comprising late-transition-metal core encapsulated by metal oxide shell, said shell comprising CeO₂, HfO₂, TiO₂, ZnO, ZrO₂, or a combination thereof. In related embodiments the late-transition-metal core comprises a noble metal, for example Pd or Pt. In some embodiments the late-transition-metal core has a diameter in a range of about 1 nm to about 10 nm. In other embodiments the late-transition-metal core has a diameter in a range of about 1 to about 5 nm. In still other embodiments, the late-transition-metal core has a diameter of about 2 nm.

Other embodiments of the invention provide for core-shell nanoparticulate compositions, each composition comprising late-transition-metal core having no more than a minor proportion of Pd, the late-transition-metal core being encapsulated by metal oxide shell. In related embodiments the late-transition-metal core comprises a noble metal, for example Pt. In other related embodiments the metal oxide shell comprises at least one oxide of a metal of Group 3, 4, or 5. In some related embodiments the metal oxide shell comprises CeO₂, HfO₂, TiO₂, ZnO, ZrO₂, or a combination thereof. In some embodiments the late-transition-metal core has a diameter in a range of about 1 nm to about 10 nm. In other embodiments the late-transition-metal core has a diameter in a range of about 1 to about 5 nm. In still other embodiments, the late-transition-metal core has a diameter of about 2 nm.

Certain embodiments of the invention provide for methods of preparing core-shell nanoparticulate compositions, the particles of which comprise Pt core encapsulated by metal oxide shell, each method comprising: reducing a Pt(II) salt in the presence of excess C₍₆₋₁₈₎-alkylamine with an alkali metal alkylborohydride, for example lithium alkylborohydride, to form an alkylamine-coated Pt metal nanoparticle; contacting the alkylamine-coated Pt metal nanoparticle with a linking compound having a formula: HS—R¹—R², where R¹ is 3 to 18 carbon atoms long and R² is a carboxylic acid or alcohol group, to form a Pt metal nanoparticle coated with linking compound; and contacting the Pt metal nanoparticle coated with linking compound with at least one metal alkoxide to form metal alkoxide linked to the Pt metal nanoparticle core. In related embodiments, methods further provide that the metal alkoxide superposed on Pt metal nanoparticle core is hydrolyzed, optionally in the presence of C₍₆₋₁₈₎-alkylcarboxylic acid, to form Pt metal core encapsulated by metal alkoxide shell. In other related embodiments, methods further provide that the Pt metal core encapsulated by metal alkoxide shell is calcined to provide core shell nanoparticle comprising transition metal core encapsulated by metal oxide shell. In some related embodiments the Pt(II) salt comprises potassium tetrachloroplatinate(II). In other related embodiments the C₍₆₋₁₈₎-alkylamine comprises dodecylamine. In still other related embodiments the alkali metal alkylborohydride is a lithium alkylborohydride, preferably comprising lithium triethylborohydride. In some related embodiments the metal alkoxide comprises zirconium or titanium alkoxides, for example zirconium(IV) tetrakis(butoxide) or a titanium(IV) butoxide. In other related embodiments the linking compound comprises 11-mercaptoundecanoic acid. In still other related embodiments the C₍₆₋₁₈₎-alkylcarboxylic acid comprises dodecanoic acid. In some embodiments the relative amounts of Pt metal nanoparticle coated with linking compound and metal alkoxide are effective to form Pt metal nanoparticle encapsulated by a metal oxide shell, the nanoparticle comprising Pt in a range of from about 5 to about 25%, preferably about 10%, relative to the weight of the entire core shell particle, the balance being a metal oxide shell.

Certain embodiments of the invention provide for compositions, each composition comprising a plurality of core-shell nanoparticles displayed on a metal oxide support, the core-shell nanoparticles comprising Pt core encapsulated by metal oxide shell. In some related embodiments the metal oxide shell comprises at least one oxide of a metal of Group 3, 4, or 5. In some related embodiments the metal oxide shell comprises CeO₂, HfO₂, TiO₂, ZnO, ZrO₂, or a combination thereof. In some embodiments the late-transition-metal core has a diameter in a range of about 1 nm to about 10 nm. In other embodiments the late-transition-metal core has a diameter in a range of about 1 to about 5 nm.

Some embodiments of the invention provide for methods of catalyzing a water-gas shift reaction, each method comprising: contacting H₂O and CO with a plurality of core-shell nanoparticulate compositions, at least one core-shell nanoparticulate comprising late-transition-metal core encapsulated by metal oxide shell, said shell comprising CeO₂, HfO₂, TiO₂, ZnO, ZrO₂, or a combination thereof, the plurality of core-shell nanoparticulate compositions being displayed on a metal oxide support, under conditions effective to form H₂ and CO₂, including those conditions described herein.

Other embodiments of the invention provide for methods of catalyzing a water-gas shift reaction, each method comprising: contacting H₂O and CO with a plurality of core-shell nanoparticulate compositions, at least one core-shell nanoparticulate comprising late-transition-metal core having no more than a minor proportion of Pd, the late-transition-metal core being encapsulated by metal oxide shell, the plurality of core-shell nanoparticulate compositions being displayed on a metal oxide support, under conditions effective to form H₂ and CO₂, including those conditions described herein.

Some embodiments of the invention provide for compositions, each composition comprising a plurality of core-shell nanoparticles comprising late-transition-metal core encapsulated by metal oxide shell and displayed on a silica intermediate layer that is attached to a metal oxide support. In certain of these embodiments, the plurality of core-shell nanoparticles are displayed as a substantially single layer superposed on a metal oxide support. In some related embodiments the late-transition-metal core comprises at least one metal of Group 8, 9, 10, or 11, such as Ru, Co, Rh, Ir, Ni, Pd, Pt, Cu, Ag, Au, or a combination thereof. In other related embodiments the late-transition-metal core comprises a noble metal. In still other related embodiments the late-transition-metal core comprises Pd or Pt. In some embodiments the late-transition-metal core has a diameter in a range of about 1 nm to about 10 nm. In other embodiments the late-transition-metal core has a diameter in a range of about 1 to about 5 nm. In still other embodiments, the late-transition-metal core has a diameter of about 2 nm. In some related embodiments the metal oxide shell comprises at least one oxide of a metal of Group 3, 4, or 5. In some embodiments the metal oxide shell comprises CeO₂, HfO₂, TiO₂, ZnO, ZrO₂, or a combination thereof. In certain embodiments, a fuel cell comprises a composition of the invention.

Some embodiments of the invention provide for compositions, each composition comprising a plurality of core-shell nanoparticles comprising late-transition-metal core encapsulated by metal oxide shell and displayed as a substantially single layer superposed on metal oxide support. In some related embodiments the late-transition-metal core comprises at least one metal of Group 8, 9, 10, or 11, such as Ru, Co, Rh, Ir, Ni, Pd, Pt, Cu, Ag, Au, or a combination thereof. In other related embodiments the late-transition-metal core comprises a noble metal. In still other related embodiments the late-transition-metal core comprises Pd or Pt. In some embodiments the late-transition-metal core has a diameter in a range of about 1 nm to about 10 nm. In other embodiments the late-transition-metal core has a diameter in a range of about 1 to about 5 nm. In still other embodiments, the late-transition-metal core has a diameter of about 2 nm. In some related embodiments the metal oxide shell comprises at least one oxide of a metal of Group 3, 4, or 5. In some embodiments the metal oxide shell comprises CeO₂, HfO₂, TiO₂, ZnO, ZrO₂, or a combination thereof. Certain embodiments provide for fuel cells which themselves comprise one or more compositions described herein.

Still other embodiments of the invention provide for methods of preparing a plurality of core-shell nanoparticles comprising late-transition-metal core encapsulated by metal oxide shell and displayed on a support comprising metal oxide, each method comprising: contacting a hydrophilic metal oxide support with an organosilane to form a hydrophobic metal oxide support; and contacting the hydrophobic metal oxide support with a plurality of core-shell nanoparticles comprising late-transition-metal core encapsulated by metal alkoxide shell to form a plurality of core-shell nanoparticles displayed on a siloxane intermediate layer that is attached to a metal oxide support. Certain related methods further comprise dispersing the hydrophobic metal oxide support in solvent. Some related methods further comprise calcining the plurality of core-shell nanoparticles displayed on a siloxane intermediate layer that is attached to a metal oxide support to form a plurality of core-shell nanoparticles comprising late-transition-metal core encapsulated by metal oxide shell displayed on a silica layer that is attached to a metal oxide support. In some embodiments, organosilane comprises triethoxy(octyl)silane. In some embodiments, late-transition-metal core comprises Pd. In some embodiments metal oxide shell comprises CeO₂. In other embodiments, late-transition-metal core comprises Pd and metal oxide shell comprises CeO₂. In other embodiments, hydrophilic metal oxide support comprises Al₂O₃.

Certain embodiments of the invention provide for methods of catalyzing the combustion of a hydrocarbon, each method comprising: contacting said hydrocarbon with a plurality of core-shell nanoparticles comprising late-transition-metal core encapsulated by metal oxide shell and displayed on a silica intermediate layer that is attached to a metal oxide support, in the presence of O₂ under conditions sufficient to form H₂O and CO₂. In some related embodiments hydrocarbon comprises methane. In some embodiments, late-transition-metal core comprises Pd. In some embodiments metal oxide shell comprises CeO₂. In other embodiments, hydrophilic metal oxide support comprises Al₂O₃. In still other embodiments late-transition-metal core comprises Pd, metal oxide shell comprises CeO₂, and metal oxide support comprises Al₂O₃.

Certain other embodiments of the invention provide for methods of catalyzing the combustion of a hydrocarbon, each method comprising: contacting said hydrocarbon with a plurality of core-shell nanoparticles comprising late-transition-metal core encapsulated by metal oxide shell and displayed as a substantially single layer superposed on metal oxide support, in the presence of O₂ under conditions sufficient to form H₂O and CO₂, including those conditions described herein. In some related embodiments hydrocarbon comprises methane. In some embodiments, late-transition-metal core comprises Pd. In some embodiments metal oxide shell comprises CeO₂. In other embodiments, metal oxide support comprises Al₂O₃. In still other embodiments late-transition-metal core comprises Pd, metal oxide shell comprises CeO₂, and metal oxide support comprises Al₂O₃.

Some embodiments of the invention provide for methods of catalyzing a water-gas shift reaction, each method comprising: contacting H₂O and CO with a plurality of core-shell nanoparticles comprising late-transition-metal core encapsulated by metal oxide shell and displayed on a silica intermediate layer that is attached to a metal oxide support, under conditions sufficient to form H₂ and CO₂, including those conditions described herein. In some embodiments, late-transition-metal core comprises Pd. In some embodiments metal oxide shell comprises CeO₂. In other embodiments, metal oxide support comprises Al₂O₃. In still other embodiments late-transition-metal core comprises Pd, metal oxide shell comprises CeO₂, and metal oxide support comprises Al₂O₃.

Other embodiments of the invention provide for methods of catalyzing a water-gas shift reaction, each method comprising: contacting H₂O and CO with a plurality of core-shell nanoparticles comprising late-transition-metal core encapsulated by metal oxide shell and displayed as a substantially single layer superposed on metal oxide support, under conditions sufficient to form H₂ and CO₂. In some embodiments, late-transition-metal core comprises Pd. In some embodiments metal oxide shell comprises CeO₂. In other embodiments, metal oxide support comprises Al₂O₃. In still other embodiments late-transition-metal core comprises Pd, metal oxide shell comprises CeO₂, and metal oxide support comprises Al₂O₃.

Some embodiments of the invention provide for a methods of catalyzing a methanol reforming reaction, each method comprising: contacting H₂O and CH₃OH with a plurality of core-shell nanoparticles, said core-shell nanoparticles comprising late-transition-metal core encapsulated by metal oxide shell, the plurality of core-shell nanoparticles being displayed on a silica intermediate layer that is attached to a metal oxide support, under conditions sufficient to form H₂, CO, and CO₂, including those conditions described herein. In some embodiments, late-transition-metal core comprises Pd. In some embodiments metal oxide shell comprises CeO₂. In other embodiments, metal oxide support comprises Al₂O₃. In still other embodiments late-transition-metal core comprises Pd, metal oxide shell comprises CeO₂, and metal oxide support comprises Al₂O₃.

Other embodiments of the invention provide for methods of catalyzing a methanol reforming reaction, each method comprising: contacting H₂O and CH₃OH with a plurality of core-shell nanoparticles comprising late-transition-metal core encapsulated by metal oxide shell and displayed as a substantially single layer superposed on metal oxide support, in the presence of O₂ under conditions sufficient to form H₂, CO, and CO₂, including those conditions described herein. In some embodiments, late-transition-metal core comprises Pd. In some embodiments metal oxide shell comprises CeO₂. In other embodiments, metal oxide support comprises Al₂O₃. In still other embodiments late-transition-metal core comprises Pd, metal oxide shell comprises CeO₂, and metal oxide support comprises Al₂O₃.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 depicts one embodiment of a composition according to the present invention, in which the core-shell nanoparticles (12) are displayed on a silica intermediate layer (14), that itself is attached to a metal oxide support.

FIG. 2A-2B are schematic representations of one scenario of the agglomeration of Pd@CeO₂ structures when using the pristine alumina (FIG. 2A) and their deposition as single units after treatment of the same support with triethoxy(octyl) silane (TEOOS) (FIG. 2B).

FIG. 3A-3F show the results of TEM investigations of Pd@CeO₂ core-shell structures dispersed on hydrophobic alumina. FIGS. 3A and 3B are HAADF-STEM images after calcining to 500° C. for 5 hours (A), and (B) to 850° C. for 5 hours. In FIG. 3C the EDS spot analysis of the indicated particles are reported. FIG. 3D provides high magnification HAADF-STEM images of the Pd@CeO₂/H-Al₂O₃ catalysts calcined to 500° C., and FIG. 3E provides the corresponding EDS line profile together with a model. FIG. 3F shows an HRTEM image of a single Pd@CeO₂ structure on the Pd@CeO₂/H-Al₂O₃ catalysts calcined to 500° C. The digital diffraction patterns (DDP) of the particles in the white squares are reported in the top-right and bottom-right insets together with representative bond distances (A) and bond angles for Pd and ceria.

FIG. 4 is a schematic representation of a procedure to synthesize M@oxide nanostructures.

FIG. 5 is a schematic representation of a procedure used to prepare MUA-protected Pt nanoparticles. TOABr=tetraoctylammonium bromide.

FIG. 6A is a representative TEM image of dodecylamine-protected Pt nanoparticles (left), along with FIG. 6B a histogram indicating particle size distribution (right).

FIG. 7A is a representative TEM image of 11-mercaptoundecanoic acid-protected nanoparticles (left), along with FIG. 7B a histogram indicating particle size distribution (right).

FIG. 8 show FTIR spectra of a) dodecylamine, b) mercaptoundecanoic acid, c) dodecylamine-protected Pt nanoparticles, and d) 11-mercaptoundecanoic acid-protected Pt nanoparticles.

FIG. 9A-9B are HAADF STEM images of prepared 20 wt % Pt@80 wt % ZrO₂ (FIG. 9A) and 20 wt % Pt@80 wt % TiO₂ nanostructures (FIG. 9B). Scale bars correspond to 40 nm.

FIG. 10 are EDS spectra of a) a region containing Pt@ZrO₂ nanostructures and b) a dark-contrasted area.

FIG. 11 are EDS spectra of a) a region containing Pt@TiO₂ nanostructures and b) a dark-contrasted area.

FIG. 12A-12B are HAADF STEM images of the prepared 20 wt % Pd@80 wt % ZrO₂ (FIG. 12A) and 20 wt % Pd@ 80 wt % TiO₂ nanostructures (FIG. 12B). The scale bars correspond to 60 and 40 nm, respectively.

FIG. 13 are DRIFT spectra of a) 1 wt % Pd@9 wt % TiO₂/Al₂O₃, b) 1 wt % Pd@9 wt % ZrO₂/Al₂O₃, c) 1 wt % Pt@9 wt % TiO₂/Al₂O₃, b) 1 wt % Pt@9 wt % ZrO₂/Al₂O₃ after reduction at 423 K, followed by exposure to CO at room temperature.

FIG. 14 illustrates data obtained for differential reaction rates for WGS over 1 wt % Pd@9 wt % ZrO₂/Al₂O₃ (▴), 1 wt % Pd@9 wt % TiO₂/Al₂O₃ (♦), 1 wt % Pd@9 wt % CeO₂/Al₂O₃ (●), 1 wt % Pd/Al₂O₃ (◯) and 9.09 wt % CeO₂/Al₂O₃ (Δ).

FIG. 15 shows the evolution of transient reaction rates during WGS at 673 K over 1 wt % Pd@9 wt % CeO₂/Al₂O₃ (●), 1 wt % Pd@9 wt % TiO₂/Al₂O₃ (♦), 1 wt % Pd@9 wt % ZrO₂/Al₂O₃ (▴), 1 wt % Pt@9 wt % CeO₂/Al₂O₃ (10 by wt %) in Al₂O₃ (90 by wt %, ◯), 1 wt % Pt@9 wt % TiO₂/Al₂O₃ (10 by wt %) in Al₂O₃ (90 by wt %, ⋄), and 1 wt % Pt@ZrO₂/Al₂O₃ (◯)(10 by wt %) in Al₂O₃ (90 by wt %, Δ).

FIG. 16 shows Fourier-transform infrared (FT-IR) spectra of pristine and hydrophobic alumina showing, in this latter case, the presence of C—H stretching bands of methylene and methyl groups in the region 3000-2800 cm⁻¹.

FIG. 17 shows high angle annular dark field (HAADF)—scanning transmission electron microscopy (STEM) tilt series at different angles for the Pd@CeO₂ structures deposited on pristine alumina (top) and on the hydrophobic alumina (bottom) and calcined to 500° C. for 5 h.

FIG. 18A-18F show representative HAADF-STEM images of Pd@CeO₂ structures deposited on pristine alumina and calcined to 500° C. for 5 h. Arrows indicate bright regions that have been identified as Pd and CeO₂ by EDS analysis. In FIG. 18E, an agglomerated Pd@CeO₂ structures is shown, and in FIG. 18F its tomography reconstruction is presented.

FIG. 19 shows absorbance at 500 nm of supernatant solutions after adsorption of Pd@CeO₂ structures onto hydrophobic alumina at different weight loadings of Pd (Pd/ceria weight ratio was fixed at 1/9). In the inset, a representative spectrum of pure Pd@CeO₂ structures solution (orange squares) and a supernatant solution after adsorption of Pd@CeO₂ at Pd 0.75-wt. % (blue triangles) are reported for 400-800 nm. The occurrence of the maximum Pd@CeO₂ adsorption capability by hydrophobic alumina corresponds to a weight loading of Pd 1% and CeO₂ 9%. Considering 1 g of the catalyst, this translates into a Pd@CeO₂/H—Al₂O₃ composition of 1%, 9% and 90%, so that 10 mg of Pd are present, corresponding to 9.410⁻⁵ mol of Pd. Assuming a Pd particle size of 2 nm, this corresponds to a number of Pd atoms of ˜400 (33). Therefore, the number of Pd@CeO₂ structures is 1.4×10¹⁷. The average diameter in solution of the single structures is 20 nm, which corresponds to a cross sectional area of ˜310 nm², or 3.1˜10⁻¹⁶ m². The total area occupied by the Pd@CeO₂ structures is ˜43 m². Given that the alumina surface area is 81 m², the surface area occupied by the structures is roughly half of that available on the alumina carrier.

FIG. 20A shows N₂ adsorption-desorption isotherms. FIG. 20C shows BJH pore size distribution and FIG. 20C shows cumulative pore volumes taken from the desorption branch of the hydrophobic alumina and of Pd@CeO₂ structures deposited on the same hydrophobic alumina. Curves in FIG. 20A are vertically offset by 400 mL g⁻¹ for clarity.

FIG. 21 shows N₂ adsorption-desorption isotherms (top) and pore size distributions and cumulative pore volumes (center) for three mesoporous oxides with different textural properties. At the bottom, pictures of the supernatant solutions obtained after adsorption of Pd@CeO₂ and centrifugation.

FIG. 22 shows powder X-ray diffraction (XRD) patterns of hydrophobic alumina and Pd@CeO₂/H—Al₂O₃ material calcined to 500° C. for 5 h. Highlighted are the main reflections distinctive of the CeO₂ phase.

FIG. 23A-23E show heating and cooling (10° C. min⁻¹) light-off curves of CH₄ conversion against the temperature for all the catalysts. FIG. 23A is Pd@CeO₂/H—Al₂O₃ core-shell catalyst, FIG. 23B is Pd/CeO₂—IWI, FIG. 23C is Pd/CeO₂/Al₂O₃ IMP, and FIG. 23D is Pd/CeO₂/H—Al₂O₃ and E) Pd@CeO₂. Conditions: CH₄ (0.5 vol. %)+O₂ (2.0 vol. %) in Ar, GHSV 200,000 mL g⁻¹ h⁻¹. All the catalysts were calcined to 850° C. for 5 h and activated under reaction conditions at 850° C. for 1 h prior to the measurements. The Pd/CeO₂/H—Al₂O₃ (FIG. 23D), there is an improvement in the conversion with respect to the pristine alumina (Graph C), but still the total CH₄ conversion is obtained only at about 600° C. and the Pd—PdO decomposition is clearly visible. In the case of the Pd@CeO₂ sample (FIG. 23E) shows very poor activity due to the poor accessibility of the Pd phase after the severe calcination treatment.

FIG. 24A-24C show heating and cooling (10° C. min⁻¹) light-off curves of CH₄ conversion against the temperature for the three catalyst formulations employed. FIG. 24A is Pd@CeO₂/H-Al₂O₃ core-shell catalyst, FIG. 24B is Pd/CeO₂—IWI and FIG. 24C is Pd/CeO₂/Al₂O₃-IMP.

FIG. 25 shows the results of Temperature Programmed Oxidation (TPO) experiments for the samples Pd@CeO₂/H—Al₂O₃, Pd/CeO₂—IWI and Pd/CeO₂/Al₂O₃-IMP calcined to 850° C. for 5 h.

FIG. 26A-26D show heating and cooling (10° C. min′) light-off curves for CH₄ conversion as a function of temperature at different GHSVs for the Pd@CeO₂/H—Al₂O₃ catalyst. FIG. 26A at 50,000 mL g⁻¹ h⁻¹; FIG. 26B at 200,000 mL g⁻¹ h⁻¹; FIG. 26C at 500,000 mL g⁻¹ h⁻¹; FIG. 26D at 1,000,000 mL g⁻¹ h⁻¹.

FIG. 27 shows heating light-off curves of CH₄ conversion against the temperature for the fresh Pd@CeO₂/H—Al₂O₃ sample and after an aging treatment at 850° C. for 12 hours (Aged curve). Conditions: CH₄ (0.5 vol. %), O₂ (2.0 vol. %) in Ar, GHSV 200,000 mL g⁻¹ h⁻¹. The fresh sample was activated under reaction conditions at 850° C. for 1 h prior to the measurements.

FIG. 28 shows subsequent light-off curves for CH₄ conversion as a function of temperature for the Pd@CeO₂/H—Al₂O₃ sample. Conditions: CH₄ (0.5 vol. %)+O₂ (2.0 vol. %) in Ar, GHSV 200,000 mL g⁻¹ h⁻¹. The fresh sample was activated under reaction conditions at 850° C. for 1 h prior to the measurements.

FIG. 29A shows kinetic rate data for CH₄ oxidation on Pd@CeO₂/H-Al₂O₃ core-shell catalyst, Pd/CeO₂—IWI and Pd/CeO₂/Al₂O₃-IMP; FIG. 29B shows kinetic rate data for CH₄ oxidation on Pd@CeO₂/H-Al₂O₃ core-shell catalysts at different loadings of the structures (Pd/Ce weight ratio was kept at 1/9): Pd loading of 0.25, 0.50, 0.75 and 1.00%.

### DETAILED DESCRIPTION OF ILLUSTRATIVE EMBODIMENTS

The present invention may be understood more readily by reference to the following detailed description taken in connection with the accompanying Tables and Figures, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the method of preparing core-shell nanoparticles and supported core-shell nanoparticles and to the resulting, corresponding physical core-shell nanoparticles and supported core-shell nanoparticles themselves, as well as the referenced and readily apparent applications for such articles.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function, and the person skilled in the art will be able to interpret it as such. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, reference to values stated in ranges include each and every value within that range.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general composition or structure, each said embodiment may also be considered an independent embodiment in itself.

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially of” For those embodiments provided in terms of “consisting essentially of,” the basic and novel characteristic(s) is the ability of the composition or method to catalyze the water-gas-shift reaction or methanol reformation at conditions such as described herein as inventive.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein.

The tailored positioning of the building blocks at the nanometer scale can dramatically improve the performance of the materials through electronic and steric interactions. Heterogeneous catalysts that are used in a wide variety of industrial and environmental applications take advantage of the synergy between a support and the supported phases. For example, interactions between a metal and an oxide can have a large influence on catalytic activity. Some oxides, such as ceria, can participate in the catalytic cycle by providing reactive oxygen through formation of vacancies. In this case it is preferred that the catalytic sites are located proximate to the interface area between the metal particles and the oxide support. Indeed, dual-site mechanisms, where one reactant is activated on the metal sites and the other on the support sites, are known to exist.

For example, a nanocrystalline bilayered catalyst, with distinct Pt—CeO₂ and Pt—SiO₂ interfacial sites, can catalyze different reactions at the Pt—CeO₂ and Pt—SiO₂ sites. More typically, metal oxide interfaces are present in supported metal catalysts; and, again, the effects of these sites and of the interaction between the metal and the support can be significant. The influence of the support can be very large for the water-gas shift (WGS) reaction, for which reaction rates on CeO₂-supported Pd can be orders of magnitude larger than rates on either CeO₂ alone or Al₂O₃-supported Pd. Although the mechanisms for oxide-metal interactions are probably different for each particular catalyst system, the sites at the oxide-metal interface are certainly involved in many cases, as demonstrated by the fact that effects associated with the interfacial sites on small metal particles can also be observed when the oxides are dispersed on bulk metals.

In the present disclosure, it is demonstrated that core-shell nanostructures with Pt or Pd cores and with CeO₂, HfO₂, TiO₂, ZnO, or ZrO₂ shells can be produced. These procedures represent a viable alternative for the preparation of functional materials that can find applications in various areas of materials science, although these materials have been investigated primarily for catalytic applications.

Preparation of core-shell structures, in which metal nanoparticle cores are surrounded by porous oxide shells, is one method for optimizing the fraction of interfacial, oxide-metal sites. The strong interactions between the components of the core and the shell can lead to advanced materials for catalytic and photocatalytic applications. Besides the possibility of improved catalytic performance, the self-assembly, core-shell approach offers a powerful tool for minimizing deactivation of the catalyst by metal sintering processes. These phenomena are particularly dramatic for high temperature reactions, as is the case of CH₄ combustion.

In the present disclosure a hierarchical design of core-shell type catalysts inspired by the concepts of supramolecular chemistry in which the building blocks are pre-organized in a way to exploit their catalytic interactions to the maximum extent is also reported. Supramolecular chemistry concepts have not been widely applied in heterogeneous catalysis because of the difficulty in manipulating the metal-support interaction at the nanoscale. The pre-organization of the functionalized Pd@CeO₂ core-shell structures to disperse single units onto a modified, catalytically inert alumina carrier can be exploited. Transmission electron microscopy (TEM) has revealed that single isolated structures can be deposited and maintained even after severe thermal treatments at temperatures up to 850° C. The special configuration of the hierarchical catalyst has led to remarkably high and stable performance for the catalytic combustion of methane with reduced amounts of Pd and ceria. This particular geometry appears to stabilize the active phase of the catalyst, suppressing agglomeration of the metal particles upon high-temperature calcination and increasing the concentration of PdOₓ.

I. Core-Shell Nanoparticulate Compositions

Certain embodiments of this invention provide core-shell nanoparticulate compositions, comprising late-transition-metal core encapsulated by metal oxide shell, the metal oxide shell comprising CeO₂, HfO₂, TiO₂, ZnO, ZrO₂, or a combination thereof.

Other embodiments of this invention provide core-shell nanoparticulate compositions, the particles of which comprise late-transition-metal core having no more than a minor proportion of Pd, the late-transition-metal core being encapsulated by metal oxide shell. As used herein, unless otherwise stated, the term “minor proportion” refers to a composition having less than 50 weight % of that element. In other independent embodiments, this term may describe a composition where the transition metal core comprises less than 50 weight % Pd, while in other embodiments the transition metal core comprises less than about 40 weight % Pd, less than about 30 weight % Pd, less than about 20 weight % Pd, less than about 10 weight % Pd, or less than about 5 weight % Pd. In still other embodiments the transition metal core is essentially free of Pd.

Other embodiments of this invention provide core-shell nanoparticulate compositions, comprising late-transition-metal core encapsulated by metal alkoxide shell, the metal alkoxide comprising an alkoxide of an early-transition-metal. In some embodiments the early-transition-metal comprises Ti, Zr, Hf, Ce, or a combination thereof.

Core-shell nanoparticulate compositions of the invention each suitably comprise a plurality of core-shell nanoparticles or a single core-shell nanoparticle. In some embodiments a core-shell nanoparticulate composition is substantially homogeneous, where all or substantially all core-shell nanoparticles comprise the same late-transition-metal core material(s) and same metal oxide shell material(s). In other embodiments a core shell nanoparticulate composition is heterogeneous, comprising at least some core-shell nanoparticles having different late-transition-metal core materials, or comprising at least some core-shell nanoparticles having different metal oxide shell materials, or comprising at least some core-shell nanoparticles having both different late-transition-metal core materials and different metal oxide shell materials. Suitable core-shell nanoparticulate compositions include compositions comprising a plurality of core-shell nanoparticles that are monodisperse or polydisperse in size and/or have the same or different core diameter and/or shell thickness.

Core-shell nanoparticles of the invention may be arranged in a substantially spherical structure. As used herein, “substantially spherical” includes nanoparticles that have some minimal amount of variation in the distance between center of the nanoparticle and various points on the surface of the nanoparticle, but still retain a generally spherical shape. The term “encapsulated” in reference to a metal oxide shell or metal alkoxide shell includes the metal oxide shell or metal alkoxide shell surrounding and superposed on the late-transition-metal core. In some embodiments the metal oxide shell or metal alkoxide shell is tethered to the transition metal core by a linkage moiety.

In certain embodiments of the invention, core-shell nanoparticles comprise a late-transition-metal core. As used herein, “late-transition-metal” includes any metal of Group 8, 9, 10, and 11 of the periodic table (also referred to as Group VIII and IB). In some embodiments, the late-transition-metal core comprises Ru, Co, Rh, Ir, Ni, Pd, Pt, Cu, Ag, Au, or a combination thereof. In some embodiments, the late-transition-metal core comprises a noble metal. As used herein, the term “noble metal” includes Ru, Rh, Pd, Ag, Os, Ir, Pt, Au and combinations thereof. In preferred embodiments, the late-transition-metal core comprises Pd, Pt, or a combination thereof.

The late-transition-metal core of core-shell nanoparticles of this invention suitably has a diameter of about 1 nm to about 10 nm. In some embodiments, the late-transition-metal core has a diameter that is at least about 1 nm. In still other embodiments the late-transition-metal core has a diameter that is at most about 10 nm, about 5 nm, or about 2 nm. These approximate maxima and minima are combinable to form different embodiments of the invention. In preferred embodiments, the late-transition-metal core has a diameter of about 1 nm to about 5 nm. In other preferred embodiments, the late-transition-metal core has a diameter of about 2 nm.

In certain embodiments of the invention core-shell nanoparticles comprise a metal oxide shell. In some embodiments the metal oxide shell comprises at least one oxide of an early-transition metal. As used herein, the term “early-transition metal” refers to elements in Groups 3, 4, 5, and 6 of the periodic table, also referred to as Group IIIB, IVB, VB, and VIB, and including lanthanides, which include, for example, lanthanum, cerium, praseodymium, neodymium, samarium, europium, gadolinium, terbium, dysprosium, holmium, erbium, thulium, ytterbium, and lutetium, and actinides, which include, for example, actinium, thorium, protactinium, and uranium. In some embodiments of the invention, the metal oxide shell comprises an oxide of a metal in Group 3, 4, or 5 of the periodic table. In preferred embodiments, the metal oxide shell comprises titania (TiO₂), ceria (CeO₂), hafnia (HfO₂), zirconia (ZrO₂), zinc oxide (ZnO), or combinations thereof.

Metal oxide shells of certain core-shell nanoparticles of this invention comprising a metal oxide shell suitably have a thickness in the range of about 1 nm to about 5 nm. The thickness dimension of the metal oxide shell refers to the distance between the outer edge of the metal oxide shell and the outer edge of the late-transition-metal core. In some embodiments, the metal oxide shell has a thickness that is in the range of about 2 nm to about 5 nm. In some embodiments, core-shell nanoparticles comprising a metal-oxide shell have a diameter in the range of about 5 nm to about 12 nm.

In certain other embodiments of the invention core-shell nanoparticles comprise a late-transition-metal core encapsulated by metal alkoxide shell. In some embodiments the metal alkoxide shell comprises at least one alkoxide of an early-transition metal. In preferred embodiments, the metal alkoxide shell comprises an alkoxide of Ti, Ce, Hf, Zr, or combinations thereof.

Some metal alkoxide shells of core-shell nanoparticles of this invention comprising a metal alkoxide shell suitably have a thickness of about 1 nm to about 15 nm. The thickness dimension of the metal alkoxide shell refers to the distance between the outer edge of the metal alkoxide shell and the outer edge of the late-transition-metal core. In some embodiments, the metal alkoxide shell has a thickness that is at least about 1 nm. In some embodiments, the metal alkoxide shell has a thickness that is at least about 2 nm. In some embodiments the metal alkoxide shell has a thickness that is at most about 15 nm, 10 nm, or 5 nm. These approximate maxima and minima are combinable to form different embodiments of the invention. In preferred embodiments, the metal alkoxide shell has a thickness of about 1 nm to about 5 nm. In other preferred embodiments, the metal alkoxide shell has a thickness of about 2 nm to about 4 nm.

In preferred embodiments of the invention the late-transition-metal core comprises Pd, Pt, or a combination thereof and the metal oxide shell comprises CeO₂, HfO₂, TiO₂, ZnO, ZrO₂, or a combination thereof. These individual transition metals and metal oxides are combinable to form different embodiments of the invention.

Core-shell nanoparticles of the invention may be referred to by the shorthand X@Y, where X refers to the core material and Y refers to the shell material. For example, M@oxide refers to core-shell nanoparticle comprising metal core and further comprising oxide shell. For example, Pd@CeO₂ refers to core-shell nanoparticle comprising Pd core and comprising CeO₂ shell.

In some embodiments of the invention two active building blocks, a transition metal core and metal oxide shell, are prepared separately. Without being bound by any particular theory, the transition metal core and metal oxide shell or metal alkoxide shell may self-assemble and organize in solution to form supramolecular core-shell nanoparticles held together by metal ion-ligand coordination chemistry.

II. Method of Preparing Pt Core-Shell Nanoparticles

Other aspects of the invention provide methods comprising reducing a Pt(II) salt in the presence of excess C₍₆₋₁₈₎-alkylamine with a lithium alkylborohydride to form an alkylamine-coated Pt metal nanoparticle; contacting the alkylamine-coated Pt metal nanoparticle with linking compound having a formula: HS—R¹—R², where R¹ is a linking moiety, typically 3 to 18 carbon atoms long, and R² is a carboxylic acid or alcohol group, to form Pt metal nanoparticle coated with linking compound; and contacting the Pt metal nanoparticle coated with linking compound with at least one metal alkoxide to form metal alkoxide superposed on Pt metal nanoparticle core.

Some embodiments of the invention provide methods further comprise hydrolyzing the metal alkoxide superposed on Pt metal nanoparticle core to form core-shell nanoparticles comprising Pt core encapsulated by metal alkoxide shell. Some embodiments of the invention further comprise calcining the core-shell nanoparticles comprising Pt core encapsulated by metal alkoxide shell to form core-shell nanoparticles comprising Pt core encapsulated by metal oxide shell. In preferred embodiments, the metal oxide shell comprises titania (TiO₂), ceria (CeO₂), zirconia (ZrO₂), hafnia (HfO₂), zinc oxide (ZnO), or a combination thereof.

Other embodiments of the invention comprise contacting core-shell nanoparticles comprising Pt core encapsulated by metal alkoxide shell with a support to form supported core-shell nanoparticles comprising Pt core encapsulated by metal alkoxide shell. Some embodiments of the invention comprise the further step of calcining the supported core-shell nanoparticles comprising Pt core encapsulated by metal alkoxide shell to form supported core-shell nanoparticles comprising Pt core encapsulated by metal oxide shell. Exemplary reaction conditions are described in the Examples herein.

In some embodiments Pt(II) salt is prepared by dissolving a Pt(II) salt in an aqueous solution to form a Pt(II) ion and transferring the Pt(II) ion from the aqueous phase to an organic phase. One exemplary Pt(II) salt includes K₂PtCl₄. The organic phase suitably includes organic solvents or combinations of organic solvents that can withstand a strong reducing agent, for example dichloromethane (CH₂Cl₂), tetrahydrofuran (THF), chloroform (CHCl₃), acetonitrile (CH₃CN), or combinations thereof. Other suitable solvents should be apparent to a person of skill in the art. A transfer agent may be used to transfer the Pt(II) ion from the aqueous phase to the organic phase. Suitable transfer agents include tetraalkylammonium halide salts, including, for example, tetraoctylammonium bromide (TOABr).

The Pt(II) ion may be coated with an alkylamine or other ligand that is compatible with a strong reducing agent. The term coated may refer to any number of alkylamine or other ligands being attached to or surrounding the Pt(II) ion. Suitable alkylamines include alkylamines comprising at least 3, 6, or 9 carbon atoms, and up to 12, 15, or 18 carbon atoms. These approximate maxima and minima are combinable to form different embodiments of the invention. In some embodiments alkylamine is C₍₆₋₁₈₎-alkylamine. In preferred embodiments alkylamine is dodecylamine. Excess alkylamine is preferably used so that the Pt(II) ion is sufficiently coated, for example, greater than 6 equivalents of alkylamine, or for example, about 12 equivalents of alkylamine. In some embodiments the Pt(II) ion is contacted with a reducing agent to form alkylamine-coated Pt metal nanoparticle. Suitable reducing agents include lithium alkylborohydrides, for example, lithium triethylborohydride (LiEt₃BH). In some embodiments the resulting alkylamine-coated Pt metal nanoparticle has an average diameter less than about 5 nm. In some embodiments the resulting particles have an average diameter of less than about 3 nm.

In some embodiments the alkylamine-coated Pt metal nanoparticles are dissolved in an organic solvent or combination of organic solvents that is suitable for solvating both the alkylamine-coated Pt metal nanoparticle and the Pt metal nanoparticle coated with linking compound that is to be prepared. In some embodiments the alkylamine-coated Pt metal nanoparticle is at least partially, and preferably substantially, soluble in relatively non-polar solvents, for example CH₂Cl₂, toluene or alkanes. In some embodiments the Pt metal nanoparticles coated with linking compound are at least partially, and preferably substantially, soluble in relatively polar solvents, for example tetrahydrofuran (THF), ethanol, methanol, N,N′-dimethylformamide (DMF), acetone, or combinations thereof. One example of a suitable combination of solvents that may solvate both the alkylamine-coated Pt metal nanoparticle and the Pt metal nanoparticle coated with linking compound is CH₂Cl₂ and THF.

In some embodiments the alkylamine-coated Pt metal nanoparticle is contacted with linking compound having a formula: HS—R¹—R², where R¹ is typically 3 to 18 carbon atoms long and R² is a carboxylic acid or alcohol group, to form a Pt metal nanoparticle coated with linking compound. The amount of linking compound coating a Pt metal nanoparticle may vary from particle to particle within a composition of Pt metal nanoparticles coated with linking compound. Without being limited to any particular theory, it may be that the mercapto group bonds to the Pt metal particle with the R¹ carbon chain providing a spacer unit between the Pt metal particle and the R² carboxylic acid or alcohol group. In some embodiments R¹ is 3 to 18 carbon atoms long. In other embodiments R¹ is 6 to 15 carbon atoms long. Preferably the linking compound is 10 carbon atoms long, such as 11-mercaptoundecanoic acid.

Without being limited to any particular theory, it may be that when the alkylamine-coated Pt metal nanoparticle is contacted with linking compound, the alkylamine ligand is efficiently replaced by the linking compound due to the strong and favored Pt—S bond. In some embodiments substantially all of the alkylamine ligands are replaced with linking compound. In other embodiments there is exchange of greater than about 90% of the alkylamine ligand with linking compound, while in still other embodiments there is exchange of a majority of the alkylamine ligand with linking compound. In some embodiments the resulting Pt metal nanoparticle coated with linking compound has an average diameter less than about 5 nm. In other embodiments the resulting particles have an average diameter of less than about 3 nm.

In some embodiments the Pt metal nanoparticle coated with linking compound is contacted with at least one metal alkoxide to form metal alkoxide superposed on Pt metal nanoparticle core. In accordance with the invention a solution of Pt metal nanoparticle coated with linking compound may be added to a solution of metal alkoxide. In some embodiments the metal alkoxide comprises at least one alkoxide of an early-transition metal. In some embodiments the metal alkoxide may have alkyl chains at least 3 carbon atoms long. In other embodiments the metal alkoxide may have alkyl chains at least 4 carbon atoms long. In some embodiments the metal alkoxide comprises zirconium(IV) tetrakis(butoxide), titanium(IV) butoxide, cerium(IV) tetrakis(decyloxide), or a combination thereof.

Some embodiments of the invention include the further step of hydrolyzing the metal alkoxide superposed on Pt metal nanoparticle core, optionally in the presence of alkylcarboxylic acid, to form core-shell nanoparticles comprising Pt core encapsulated by metal alkoxide shell. Without being limited to any particular theory, addition of alkylcarboxylic acid may slow hydrolysis of the metal alkoxide shell and confer solubility on the final Pt metal nanoparticle encapsulated by metal alkoxide shell. Suitable alkylcarboxylic acids include alkylcarboxylic acids comprising at least 3, 6, or 9 carbon atoms, and up to 12, 15, or 18 carbon atoms. These approximate maxima and minima are combinable to form different embodiments of the invention. In some embodiments alkylcarboxylic acid is C₍₆₋₁₈₎-alkylcarboxylic acid. In preferred embodiments alkylamine is dodecanoic acid. Some embodiments of the invention include the further step of calcining the core-shell nanoparticles comprising Pt core encapsulated by metal alkoxide shell to form core-shell nanoparticles comprising Pt core encapsulated by metal oxide shell.

In accordance with the invention, the composition of the Pt metal nanoparticle encapsulated by metal oxide shell can be tuned by varying the relative amounts of Pt metal nanoparticle coated with linking compound and metal alkoxide that are contacted. In some embodiments the relative amounts of Pt metal nanoparticle coated with linking compound and metal alkoxide are effective to form a Pt metal nanoparticle encapsulated by a metal shell comprising about 10% Pt and about 90% metal oxide by weight.

Without being limited to any particular theory, it may be that an excess amount of Pt metal nanoparticle coated with linking compound relative to the amount of metal alkoxide results in discrete Pt nanoparticles coated with linking compound binding to the same metal alkoxide moiety. It is preferred that the Pt metal nanoparticle coated with linking compound is added to a solution of excess metal alkoxide. Without being limited to any particular theory, adding the Pt metal nanoparticle coated with linking compound to excess metal alkoxide may prevent agglomeration of the Pt metal nanoparticles coated with linking compound. Without being limited by any particular theory, it may be that a carboxylic acid or alcohol moiety on Pt metal nanoparticle coated with linking compound replaces an alkoxy group on metal alkoxide, resulting in self-assembly of metal alkoxide shell. One indication that coupling between the metal alkoxide and the Pt metal nanoparticles coated with linking compound was successful is the resulting metal alkoxide superposed on a Pt metal nanoparticle core is soluble in low-polarity solvents such as toluene and alkanes; in some embodiments the Pt metal nanoparticles coated with linking compound are insoluble in such solvents.

III. Method of Preparing Pd Core-Shell Nanostructures

In another aspect of the invention, there is also provided a method comprising: contacting Pd(II) ion with linking compound having a formula: HS—R¹—R², where R¹ is a linking moiety, typically 3 to 18 carbon atoms long and R² is a carboxylic acid or alcohol group, to form a Pd(II) ion nanoparticle coated with linking compound; reducing the Pd(II) ion nanoparticle coated with linking compound with a borohydride to form a Pd metal nanoparticle coated with linking compound and contacting the Pd metal nanoparticle coated with linking compound with at least one metal alkoxide to form metal alkoxide superposed on Pd metal nanoparticle core.

Some embodiments of the invention provide methods further comprising hydrolyzing the metal alkoxide superposed on Pd metal nanoparticle core to form core-shell nanoparticles comprising Pd core encapsulated by metal alkoxide shell. Some embodiments of the invention further comprise calcining the core-shell nanoparticles comprising Pd core encapsulated by metal alkoxide shell to form core-shell nanoparticles comprising Pd core encapsulated by metal oxide shell. In preferred embodiments, the metal oxide shell comprises titania (TiO₂), ceria (CeO₂), zirconia (ZrO₂), hafnia (HfO₂), zinc oxide (ZnO), or a combination thereof.

Other embodiments of the invention comprise contacting core-shell nanoparticles comprising Pd core encapsulated by metal alkoxide shell with a support to form supported core-shell nanoparticles comprising Pd core encapsulated by metal alkoxide shell. Some embodiments of the invention comprise the further step of calcining the supported core-shell nanoparticles comprising Pd core encapsulated by metal alkoxide shell to form supported core-shell nanoparticles comprising Pd core encapsulated by metal oxide shell. Exemplary reaction conditions are described in the Examples herein.

In some embodiments Pd(II) salt is prepared by dissolving a Pd(II) salt in an aqueous solution and transferring the Pd(II) ion from the aqueous phase to an organic phase. Exemplary Pd(II) salts include K₂PdCl₄, Pd(NO₃)₂, and PdCl₂. The organic phase suitably includes organic solvents or combinations of organic solvents that can withstand a strong reducing agent, for example dichloromethane (CH₂Cl₂), tetrahydrofuran (THF), chloroform (CHC₁₃), acetonitrile (CH₃CN), or combinations thereof. Other suitable solvents will be apparent to a person of skill in the art. A transfer agent may be used to transfer the Pd(II) ion from the aqueous phase to the organic phase. Suitable transfer agents include tetraalkylammonium halide salts, including, for example, tetraoctylammonium bromide (TOABr).

In some embodiments the Pd(II) ion is contacted with linking compound having a formula: HS—R¹—R², where R¹ is a linking moiety, typically 3 to 18 carbon atoms long, and R² is a carboxylic acid or alcohol group, and is suitable to form a Pd(II) ion nanoparticle coated with linking compound. The amount of linking compound coating a Pd(II) ion nanoparticle may vary from particle to particle within a composition of Pd metal nanoparticles coated with linking compound. Without being limited to any particular theory, it may be that the mercapto group bonds to the Pd metal particle with the R¹ carbon chain providing a spacer unit between the Pd metal particle and the R² carboxylic acid or alcohol group. In some embodiments R¹ is 3 to 18 carbon atoms long. In other embodiments R¹ is 6 to 15 carbon atoms long. Preferably the linking compound is 10 carbon atoms long, such as 11-mercaptoundecanoic acid.

In some embodiments, the Pd(II) ion nanoparticle coated with linking compound is contacted with a reducing agent to form Pd metal nanoparticle coated with linking compound. Suitable reducing agents include borohydrides, for example, sodium borohydride (NaBH₄).

In some embodiments the Pd metal nanoparticle coated with linking compound is contacted with at least one metal alkoxide to form metal alkoxide superposed on Pd metal nanoparticle core. In accordance with the invention a solution of Pd metal nanoparticle coated with linking compound may be added to a solution of metal alkoxide. In some embodiments the metal alkoxide comprises at least one alkoxide of an early transition metal. In preferred embodiments, the metal alkoxide comprises zirconium(IV) tetrakis(butoxide), titanium(IV) butoxide, cerium(IV) tetrakis(decyloxide), or a combination thereof.

In some embodiments the metal alkoxide comprises alkyl chains at least 3 carbon atoms long. In other embodiments the metal alkoxide comprises alkyl chains at least 4 carbon atoms long. In still other embodiments the metal alkoxide comprises alkyl chains about 10 carbon atoms long.

Some embodiments of the invention include the further step of hydrolyzing the metal alkoxide superposed on Pd metal nanoparticle core, optionally in the presence of alkylcarboxylic acid, to form core-shell nanoparticles comprising Pd core encapsulated by metal alkoxide shell. Without being limited to any particular theory, addition of alkylcarboxylic acid may slow hydrolysis of the metal alkoxide shell and confer solubility on the final Pd metal nanoparticle encapsulated by metal alkoxide shell. In some embodiments the alkylcarboxylic acid is C₍₆₋₁₈₎-alkylcarboxylic acid. In other embodiments the alkylcarboxylic acid is a C₍₈₋₁₆₎-alkylcarboxylic acid. Preferably, the alkylcarboxylic acid is dodecanoic acid. Some embodiments of the invention include the further step of calcining the core-shell nanoparticles comprising Pd core encapsulated by metal alkoxide shell to form core-shell nanoparticles comprising Pd core encapsulated by metal oxide shell.

In accordance with the invention, the composition of the Pd metal nanoparticle core encapsulated by a metal oxide shell can be tuned by varying the relative amounts of Pd metal nanoparticle coated with linking compound and metal alkoxide that are contacted. In some embodiments the relative amounts of Pd metal nanoparticle coated with linking compound and metal alkoxide are effective to form a Pd metal nanoparticle encapsulated by a metal shell comprising about 10% Pd and about 90% metal oxide by weight.

Without being limited to any particular theory, it may be that an excess amount of Pd metal nanoparticle coated with linking compound relative to metal alkoxide results in discrete Pd nanoparticles coated with linking compound binding to the same metal alkoxide moiety. It is preferred that the Pd metal nanoparticle coated with linking compound is added to a solution of excess metal alkoxide. Without being limited to any particular theory, adding the Pd metal nanoparticle coated with linking compound to excess metal alkoxide may prevent agglomeration of the Pd metal nanoparticles coated with linking compound. Without being limited by any particular theory, it may be that a carboxylic acid or alcohol moiety on Pd metal nanoparticle coated with linking compound replaces an alkoxy group on metal alkoxide, resulting in self-assembly of metal alkoxide shell. Without being bound by a particular theory, an indication that coupling between the metal alkoxide and the Pd metal nanoparticles coated with linking compound is successful is the resulting metal alkoxide superposed on a Pd metal nanoparticle core is soluble in low-polarity solvents such as toluene and alkanes; in some embodiments the Pd metal nanoparticles coated with linking compound are insoluble in such solvents.

IV. Core-Shell Nanoparticles Displayed on Support

In another aspect of the invention, there are provided compositions comprising a plurality of core-shell nanoparticles displayed on a support, the core-shell nanoparticles comprising Pt core encapsulated by metal oxide shell. As used herein, a “support” includes structures for holding core-shell particles in position. In some embodiments, a support is relatively inert to the core-shell nanoparticles to be displayed and under the reaction conditions to be applied, for example in a catalysis reaction. In some embodiments the support comprises metal oxide. In other embodiments the support comprises carbon. In other embodiments of the invention, there are provided compositions comprising a plurality of core-shell nanoparticles displayed on a support, the core-shell nanoparticles comprising Pt core encapsulated by metal alkoxide shell.

In another aspect of the invention, there is provided a composition comprising a plurality of core-shell nanoparticles displayed on a metal oxide support, the core-shell nanoparticles comprising Pt core encapsulated by metal oxide shell. In still another aspect of the invention, there is provided a composition comprising a plurality of core-shell nanoparticles displayed on a metal oxide support, the core-shell nanoparticles comprising Pt core encapsulated by metal alkoxide shell. Core-shell nanoparticles comprising Pt core encapsulated by metal oxide shell and core-shell nanoparticles comprising Pt core encapsulated by metal alkoxide shell suitable for use in this aspect of the invention have been described above. In some embodiments, the metal oxide support comprises at least one oxide of a metal of Periods 3 or 4 of the periodic table. The metal oxide support suitably includes any oxide comprising pores large enough to accommodate entry of core-shell nanoparticles comprising Pt core encapsulated by metal oxide shell. In some embodiments metal oxide support comprises Al₂O₃, ZrO₂, TiO₂, SiO₂, La₂O₃, La-doped Al₂O₃, barium hexaaluminate, or combinations thereof.

In another aspect of the invention, there are provided compositions comprising a plurality of core-shell nanoparticles displayed on a metal oxide support, the core-shell nanoparticles comprising late-transition-metal core having no more than a minor proportion of Pd, the late-transition-metal core being encapsulated by metal oxide shell. In other embodiments of the invention, there are provided compositions comprising a plurality of core-shell nanoparticles displayed on a metal oxide support, the core-shell nanoparticles comprising late-transition-metal core having no more than a minor proportion of Pd, the late-transition-metal core being encapsulated by metal alkoxide shell. Core-shell nanoparticles comprising late-transition-metal core having no more than a minor proportion of Pd encapsulated by metal oxide shell and core-shell nanoparticles comprising late-transition-metal core having no more than a minor proportion of Pd encapsulated by metal alkoxide shell suitable for use in this aspect of the invention have been described above. In some embodiments, the metal oxide support comprises at least one oxide of a metal of Periods 3 or 4 of the periodic table. The metal oxide support suitably includes any oxide comprising pores large enough to accommodate entry of core-shell nanoparticles comprising transition metal core having no more than a minor proportion of Pd encapsulated by metal-oxide shell. In some embodiments the metal oxide support comprises pores having a diameter greater than about 13 nm. In other embodiments the metal oxide support comprises pores having a diameter greater than about 15 nm. In some embodiments metal oxide support comprises Al₂O₃, ZrO₂, TiO₂, SiO₂, La₂O₃, La-doped Al₂O₃, barium hexaaluminate, or combinations thereof.

As used herein, “displayed” includes core-shell nanoparticles being superposed on a support such that the core-shell nanoparticle is accessible to reactants. Particles that are superposed on a support include particles that are in contact with the support, particles that are separated from the support by one or more intermediate layers, and particles that are tethered to the support by a linkage, among other arrangements.

Other embodiments of the invention provide for methods of catalysis comprising contacting appropriate reactants with supported core-shell nanoparticles of the invention.

In some embodiments, compositions of the invention comprising a plurality of core-shell nanoparticles displayed on a metal oxide support are prepared by dissolving a plurality of core-shell nanoparticles in solvent. In some embodiments the core-shell nanoparticles comprise a metal alkoxide shell. In some embodiments, the solvent is a polar solvent, for example THF. An appropriate mass of metal oxide support to achieve the desired ratio of core-shell nanoparticles to metal oxide support is added to the solution to form supported core-shell nanoparticles comprising metal alkoxide shell. The mixture may be stirred, the solvent removed, and the resulting powder dried. In some embodiments the supported core-shell nanoparticles comprising metal alkoxide shell may be calcined to form supported core-shell nanoparticles comprising metal oxide shell.

In another aspect of the invention, there are provided methods of catalyzing a water-gas shift reaction, each method comprising contacting H₂O and CO with a plurality of core-shell nanoparticulate compositions, at least one core-shell nanoparticulate composition comprising transition metal core encapsulated by metal oxide shell comprising CeO₂, HfO₂, TiO₂, ZnO, ZrO₂, or a combination thereof, the plurality of core-shell nanoparticulate compositions being displayed on a metal oxide support, under conditions effective to form H₂ and CO₂, including those conditions described herein.

In another aspect of the invention, there are provided methods of catalyzing a water-gas shift reaction, each method comprising contacting H₂O and CO with a plurality of core-shell nanoparticles, at least one core-shell nanoparticle comprising transition metal core having no more than a minor proportion of Pd, the transition metal core being encapsulated by a metal oxide shell, the plurality of core-shell nanoparticulate compositions being displayed on a metal oxide support under conditions effective to form H₂ and CO₂, including those conditions described herein.

V. Core-Shell Nanoparticles Displayed as Substantially Single Layer Superposed on Support

Some embodiments of the invention provide compositions comprising a plurality of core-shell nanoparticles, said core-shell nanoparticles comprising late-transition-metal core encapsulated by metal oxide shell and displayed as a substantially single layer superposed on hydrophobic support. In some embodiments the hydrophobic support comprises carbon.

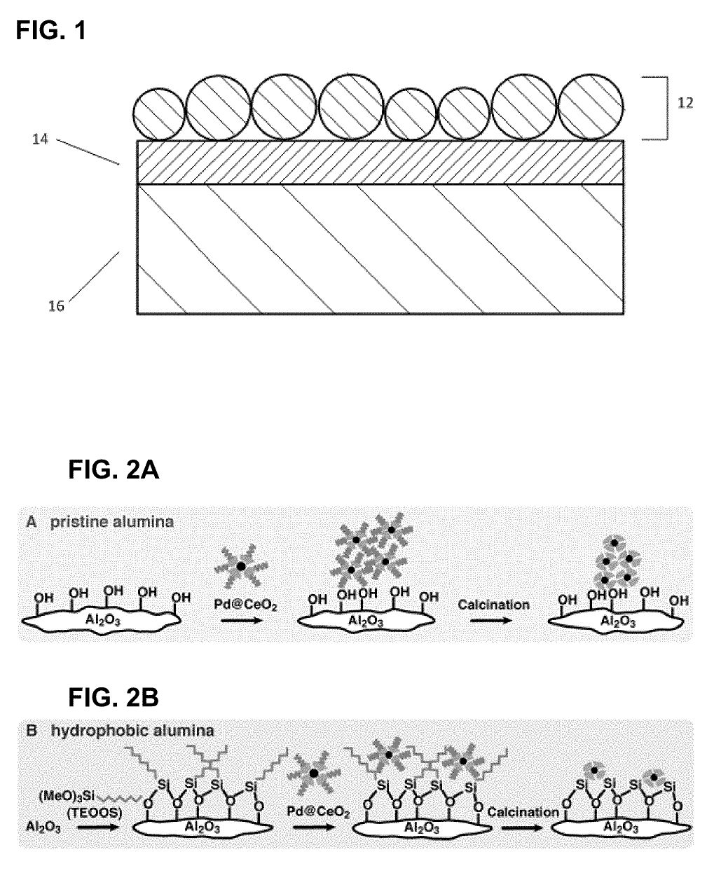

Other embodiments of the invention provide compositions comprising a plurality of core-shell nanoparticles, said core-shell nanoparticles comprising late-transition-metal core encapsulated by metal oxide shell and displayed on a silica intermediate layer that is attached to a metal oxide support. FIG. 1 depicts one embodiment of a composition according to the present invention. As shown in the figure, the core-shell nanoparticles (12) are displayed on a silica intermediate layer (14) that is attached to a metal oxide support (16). In some embodiments the core-shell nanoparticles are displayed on a silica intermediate layer as a substantially single layer.

Still other embodiments of the invention, provide compositions comprising a plurality of core-shell nanoparticles, said core-shell nanoparticles comprising late-transition-metal core encapsulated by metal oxide shell and displayed as a substantially single layer superposed on metal oxide support.

Some embodiments of the invention provide compositions comprising a plurality of core-shell nanoparticles, said core-shell nanoparticles comprising late-transition-metal core encapsulated by metal alkoxide shell and displayed as a substantially single layer superposed on hydrophobic support. In some embodiments the hydrophobic support comprises carbon.

Other embodiments of the invention provide compositions comprising a plurality of core-shell nanoparticles, said core-shell nanoparticles comprising late-transition-metal core encapsulated by metal alkoxide shell and displayed on a siloxane intermediate layer that is attached to a metal oxide support.

Still other embodiments of the invention, provide compositions comprising a plurality of core-shell nanoparticles, said core-shell nanoparticles comprising late-transition-metal core encapsulated by metal alkoxide shell and displayed as a substantially single layer superposed on metal oxide support.

Suitable core-shell nanoparticles may be any of the core-shell nanoparticulate compositions described herein. In preferred embodiments, the transition metal core comprises Pd, Pt, or a combination thereof. In preferred embodiments, the metal oxide shell comprises titania (TiO₂), ceria (CeO₂), zirconia (ZrO₂), hafnia (HfO₂), zinc oxide (ZnO), or a combination thereof. Most preferably, the late-transition-group metal core comprises Pd and the metal oxide shell comprises CeO₂.

As used herein, “single layer” includes a contiguous layer of core-shell nanoparticles superposed on at least a portion of metal oxide support, including islands of core-shell nanoparticles superposed on metal oxide support in contact with each other without covering the entire surface of the metal oxide support, as well as individual core-shell nanoparticles superposed on metal oxide support in isolation from other core-shell nanoparticles. In some embodiments of the invention core-shell nanoparticles are superposed on metal oxide support in a regular pattern. As used herein, “regular pattern” refers to an arrangement of core-shell nanoparticles wherein islands of nanoparticles are substantially the same size and are spaced substantially equidistant from one another or in a repeating pattern. In other embodiments of the invention core-shell nanoparticles are superposed on metal oxide support in an irregular distribution. As used herein, “irregular distribution” refers to an arrangement of core-shell nanoparticles wherein some islands of nanoparticles differ in size and/or are spaced such that no definable pattern is formed. In preferred embodiments the core-shell nanoparticles are superposed in a single layer on metal oxide support, but it is also contemplated that occasional agglomeration or overlapping of core-shell nanoparticles amid a generally single layer are within the scope of the invention.

Some embodiments of the invention comprise a support. As used herein, a “support” includes structures for holding core-shell particles in position. In some embodiments, support is relatively inert to the core-shell nanoparticles to be displayed and under the reaction conditions to be applied, for example in a catalysis reaction. Supports suitable for compositions of the invention include metal oxides. In some embodiments, the metal oxide support comprises at least one oxide of a metal of Periods 3 or 4 of the periodic table. Metal oxide supports may suitably include any metal oxide comprising pores large enough to accommodate entry of core-shell nanoparticles comprising transition metal core having no more than a minor proportion of Pd encapsulated by metal oxide shell. In some embodiments metal oxide support comprises Al₂O₃, ZrO₂, TiO₂, SiO₂, La₂O₃, La-doped Al₂O₃, barium hexaaluminate, or combinations thereof.

Various embodiments of the invention comprise a hydrophobic support. In some embodiments suitable supports comprise metal oxides that have been modified to present a hydrophobic surface. In other embodiments suitable hydrophobic supports comprise carbon.

Some embodiments of the invention provide compositions comprising a plurality of core-shell nanoparticles, said core-shell nanoparticles comprising late-transition-metal core encapsulated by metal oxide shell and displayed on a silica intermediate layer that is attached to a support is incorporated into a device. Another embodiment of the invention provides for compositions comprising a plurality of core-shell nanoparticles, said core-shell nanoparticles comprising late-transition-metal core encapsulated by metal oxide shell and displayed as a substantially single layer superposed on metal-oxide support is incorporated into a device. Still other embodiments of the invention provides for a device comprising a plurality of core-shell nanoparticles, said core-shell nanoparticles comprising late-transition-metal core encapsulated by metal oxide shell and displayed as a substantially single layer superposed on carbon support. Suitable devices include fuel cells.

VI. Method of Preparing Core-Shell Nanoparticles Displayed in Substantially Single Layer Superposed on Metal Oxide Support

Another aspect of the invention provides a method comprising: contacting a hydrophilic metal oxide support with an organosilane to form a hydrophobic metal oxide support; and contacting the hydrophobic metal oxide support with a plurality of core-shell nanoparticles comprising late-transition-metal core encapsulated by metal alkoxide shell to form a plurality of core-shell nanoparticles comprising late-transition-metal core encapsulated by metal alkoxide shell displayed on a siloxane intermediate layer that is attached to a metal-oxide support. In certain embodiments of the invention the method further comprises dispersing the hydrophobic metal oxide support in solvent. Suitable solvents include toluene.

Some embodiments further comprise calcining the plurality of core-shell nanoparticles comprising late-transition-metal core encapsulated by metal alkoxide shell displayed on a siloxane intermediate layer that is attached to a metal-oxide support to form a plurality of core-shell nanoparticles comprising late-transition-metal core encapsulated by metal oxide shell displayed on a silica intermediate layer that is attached to a metal oxide support.

Without limiting to a particular theory, it is believed that contacting the hydrophilic metal oxide support with an organosilane forms a hydrophobic siloxane intermediate layer on the metal oxide support, transforming the hydrophilic metal oxide support to a hydrophobic metal oxide support. Without limiting to a particular theory, it may be that the hydrophobic metal oxide support prevents agglomeration of the core-shell nanoparticles and results in the arrangement of the core-shell nanoparticles in a substantially single layer superposed on the surface of the metal oxide support. FIG. 2B depicts one embodiment of the invention, an arrangement of core-shell nanoparticles superposed on a siloxane layer attached to Al₂O₃, a hydrophobic support, and depicts an arrangement of core-shell nanoparticles superposed on pristine alumina, a hydrophilic support. As shown in FIG. 2A, the core-shell nanoparticles agglomerate when contacted with the hydrophilic support, and the core-shell nanoparticles arrange in a single layer when contacted with the hydrophobic support. In some embodiments the organosilane is an alkoxysilane. Suitable alkoxysilanes include trimethoxy(octyl)silane, hexamethyldisilazane, methyltrichlorosilane, and combinations thereof. In a preferred embodiment, the organosilane is triethoxy(octyl)silane (TEOOS). In a preferred embodiment of the invention, the metal oxide support comprises Al₂O₃.

In some embodiments, the hydrophobic metal oxide support has some pores of a size about the same size or greater than diameter of the core-shell nanoparticles. The hydrophobic metal oxide support suitably comprises pores large enough to accommodate entry of core-shell nanoparticles. In some embodiments the hydrophobic metal oxide support comprises pores having a diameter greater than about 13 nm. In other embodiments the hydrophobic metal oxide support comprises pores having a diameter greater than about 15 nm.

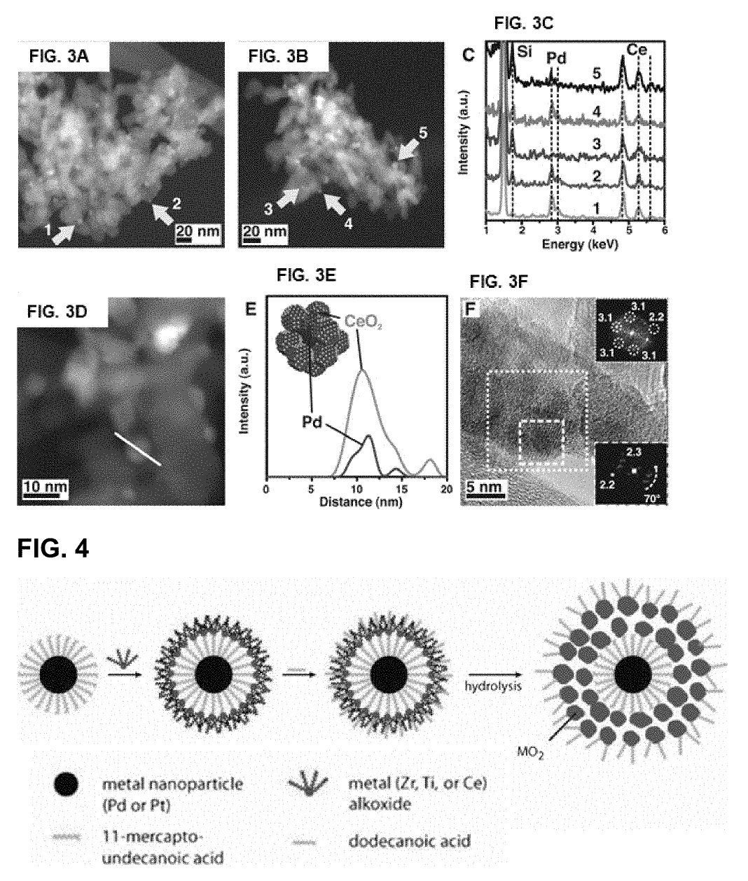

In a preferred embodiment the transition metal core comprises Pd, the metal oxide shell comprises CeO₂ and the metal oxide support comprises Al₂O₃. Without being bound to a particular theory, it may be that the functionalized Pd@CeO₂ core-shell structures disperse as single units onto a modified, otherwise catalytically inert alumina carrier. Transmission Electron Microscopy (TEM) investigations demonstrate that it is indeed possible to deposit single structures where the metal-promoter interaction is maintained even after severe thermal treatments at temperatures up to 850° C. (see FIG. 3). Without being bound to any particular theory, it may be that the special configuration of the hierarchical catalyst gives rise to exceptionally high and stable performance for the catalytic combustion of methane with reduced amounts of Pd and ceria. Without being bound by a particular theory, the particular geometry of the core-shell nanoparticles superposed on the metal oxide surface appears to over-stabilize the PdOx phase in the particles, not only preventing agglomeration of palladium oxide particles during the catalytic reaction but also preventing the PdOx from being transformed to Pd at its usual transition temperature.

VII. Alloys

Additional embodiments provide that the intimate mixtures of the core-shell compositions may be used to prepare alloys of the core and shell metals. For example, some embodiments of the invention include the further step of forming PdₓZn_{y} or PtₓZn_{y} alloys (x and y each ranging from 0 to 1 and x+y being equal to 1) by reducing the Pd@ZnO or Pt@ZnO nanoparticles, respectively, in a flow of hydrogen or under other reductive reaction conditions. Without being limited to any particular theory, reduction of these structures would cause the formation of alloys at the interface between the metal particles and the surrounding ZnO shell.

VIII. Methods of Catalysis

In various independent embodiments, the core-shell nanoparticulate compositions and the supported core-shell nanoparticle compositions are useful catalysts and may be used to catalyze, for example, the reaction of hydrocarbon with O₂ to form H₂O and CO₂, the water-gas-shift reaction between H₂O and CO to form H₂ and CO₂, or the methanol reforming reaction between H₂O and CH₃OH to form H₂, CO, and CO₂ under suitably appropriate and mild conditions. As demonstrated in specific examples herein, reactions of hydrocarbon with O₂ catalyzed by compositions of the invention can achieve complete conversion to H₂O and CO₂ at significantly lower temperatures than reactions catalyzed by the same transition metal, metal oxide, and/or support materials not configured in the supported core-shell nanoparticle arrangement of the invention.

Some embodiments of the invention provide for a method for catalyzing the combustion of a hydrocarbon comprising contacting said hydrocarbon with a plurality of core-shell nanoparticles comprising late-transition-metal core encapsulated by metal oxide shell and displayed on a silica intermediate layer that is attached to a metal oxide support, in the presence of O₂ under conditions sufficient to form H₂O and CO₂. In preferred embodiments, the hydrocarbon comprises methane. In some embodiments the reaction achieves, or is capable of achieving, substantially complete conversion at temperatures less than 500° C. In other embodiments the reaction achieves 90% conversion at a temperature less than 500° C. In other embodiments the reaction achieves, or is capable of achieving, substantially complete conversion, or at least 90% conversion at a temperature about 400° C.

Some embodiments of the invention provide for a method for catalyzing the combustion of a hydrocarbon comprising contacting said hydrocarbon with a plurality of core-shell nanoparticles comprising late-transition-metal core encapsulated by metal oxide shell and displayed as a substantially single layer superposed on metal oxide support, in the presence of O₂ under conditions sufficient to form H₂O and CO₂. In preferred embodiments, the hydrocarbon comprises methane. In some embodiments, the reaction achieves, or is capable of achieving, substantially complete conversion at temperatures less than 500° C. In other embodiments the reaction achieves, or is capable of achieving, 90% conversion at a temperature less than 500° C. In other embodiments the reaction achieves, or is capable of achieving, substantially complete conversion, or at least 90% conversion at a temperature about 400° C.

Some embodiments of the invention provide methods for catalyzing a water-gas shift reaction comprising contacting H₂O and CO with a plurality of core-shell nanoparticles comprising late-transition-metal core encapsulated by metal oxide shell and displayed on a silica intermediate layer that is attached to a metal oxide support, under conditions sufficient to form H₂ and CO₂.

Some embodiments of the invention provide methods for catalyzing a water-gas shift reaction comprising contacting H₂O and CO with a plurality of core-shell nanoparticles comprising late-transition-metal core encapsulated by metal oxide shell and displayed as a substantially single layer superposed on metal oxide support, under conditions sufficient to form H₂ and CO₂.

Some embodiments of the invention provide methods for catalyzing a methanol reforming reaction comprising contacting H₂O and CH₃OH with a plurality of core-shell nanoparticles, said core-shell nanoparticles comprising late-transition-metal core encapsulated by metal oxide shell, the plurality of core-shell nanoparticles being displayed on a silica intermediate layer that is attached to a metal oxide support, under conditions sufficient to form H₂, CO, and CO₂.

Some embodiments of the invention provide methods for catalyzing a methanol reforming reaction comprising contacting H₂O and CH₃OH with a plurality of core-shell nanoparticles comprising late-transition-metal core encapsulated by metal oxide shell and displayed as a substantially single layer superposed on metal oxide support, in the presence of O₂ under conditions sufficient to form H₂, CO, and CO₂.

Core-shell nanoparticles as described throughout this disclosure are suitable for use in methods for catalysis of the invention. In preferred embodiments the late-transition-metal core comprises Pd. In preferred embodiments, the metal oxide shell comprises CeO₂. In preferred embodiments, the metal oxide support comprises Al₂O₃. In most preferred embodiments, the late-transition-metal core comprises Pd, the metal oxide shell comprises CeO₂, and the hydrophilic metal oxide support comprises Al₂O₃.

The following listing of embodiments in intended to complement, rather than displace or supersede, the previous descriptions.

### Embodiment 1

A core-shell nanoparticulate composition comprising late-transition-metal core encapsulated by metal oxide shell, said shell comprising CeO₂, HfO₂, TiO₂, ZnO, ZrO₂, or a combination thereof.

### Embodiment 2

The composition of Embodiment 1, the late-transition-metal core comprising Pd or Pt.

### Embodiment 3

A core-shell nanoparticulate composition comprising late-transition-metal core having no more than a minor proportion of Pd, the late-transition-metal core being encapsulated by a metal oxide shell.

### Embodiment 4

The composition of Embodiment 3, the late-transition-metal core comprising Pt.

### Embodiment 5

The composition of Embodiment 3, the metal oxide shell comprising at least one oxide of a metal of Group 3, 4, or 5.

### Embodiment 6

The composition of Embodiment 3, the metal oxide shell comprising CeO₂, HfO₂, TiO₂, ZnO, ZrO₂, or a combination thereof.

### Embodiment 7

The composition of Embodiment 1 or 3, the transition metal core comprising a noble metal.

### Embodiment 8

The composition of any one of Embodiments 1 to 7, the transition metal core having a diameter in a range of about 1 nm to about 10 nm.

### Embodiment 9

The composition of any one of Embodiments 1 to 8, the transition metal core having a diameter in a range of about 1 nm to about 5 nm.

### Embodiment 10

The composition of any one of Embodiments 1 to 9, the transition metal core having a diameter of about 2 nm.

### Embodiment 11

A method comprising:

reducing a Pt(II) salt in the presence of excess C₍₆₋₁₈₎-alkylamine with a lithium alkylborohydride to form an alkylamine-coated Pt metal nanoparticle;

contacting the alkylamine-coated Pt metal nanoparticle with a linking compound having a formula:

HS—R¹—R²,

where R¹ is 3 to 18 carbon atoms long and R² is a carboxylic acid or alcohol group;

to form a Pt metal nanoparticle coated with linking compound; and contacting the Pt metal nanoparticle coated with linking compound with at least one metal alkoxide to form metal alkoxide superposed on Pt metal nanoparticle core.

### Embodiment 12

The method of Embodiment 11, the Pt(II) salt comprising potassium tetrachloroplatinate(II).

### Embodiment 13

The method of Embodiment 11 or 12, the C₍₆₋₁₈₎-alkylamine comprising dodecylamine.

### Embodiment 14

The method of any one of Embodiments 11 to 13, the lithium alkylborohydride comprising lithium triethylborohydride.

### Embodiment 15

The method of any one of Embodiments 11 to 14, the metal alkoxide comprising a zirconium(IV) tetrakis(butoxide).

### Embodiment 16

The method of any one of Embodiments 11 to 14, the metal alkoxide comprising a titanium(IV) butoxide.

### Embodiment 17

The method of any one of Embodiments 11 to 16, the linking compound comprising 11-mercaptoundecanoic acid.

### Embodiment 18

The method of any one of Embodiments 11 to 14, further comprising hydrolyzing the metal alkoxide superposed on Pt metal nanoparticle core, optionally in the presence of C₍₆₋₁₈₎-alkylcarboxylic acid, to form Pt metal core encapsulated by metal alkoxide shell.

### Embodiment 19

The method of Embodiment 18, further comprising calcining the Pt metal core encapsulated by metal oxide shell to form Pt metal core encapsulated by metal oxide shell.

### Embodiment 20

The method of Embodiment 18 or 19, wherein the relative amounts of Pt metal nanoparticle coated with linking compound and metal alkoxide are effective to form Pt metal nanoparticle encapsulated by a metal oxide shell comprising about 10% Pt and about 90% metal oxide by weight.

### Embodiment 21

The method of any one of Embodiments 18 to 20, the C₍₆₋₁₈₎-alkylcarboxylic acid comprising dodecanoic acid.

### Embodiment 22

A composition comprising: a plurality of core-shell nanoparticles displayed on a metal oxide support, the core-shell nanoparticles comprising Pt core encapsulated by metal oxide shell.

### Embodiment 23

The composition of Embodiment 22, the metal oxide shell comprising at least one oxide of a metal of Group 3, 4, or 5.

### Embodiment 24

The composition of Embodiment 22, the metal oxide shell comprising TiO₂, CeO₂, HfO₂, ZnO, or ZrO₂.

### Embodiment 25

The composition of any one of Embodiments 22 to 24, the Pt core comprising a diameter of about 1 nm to about 5 nm.

### Embodiment 26

A method for catalyzing a water-gas shift reaction comprising: contacting H₂O and CO with a plurality of core-shell nanoparticulate compositions, at least one core-shell nanoparticulate comprising a core-shell nanoparticulate composition of Embodiment 1, the plurality of core-shell nanoparticulate compositions being displayed on a metal oxide support under conditions effective to form H₂ and CO₂.

### Embodiment 27

A method for catalyzing a water-gas shift reaction comprising: contacting H₂O and CO with a plurality of core-shell nanoparticulate compositions, at least one core-shell nanoparticulate comprising a core-shell nanoparticulate composition of Embodiment 3, the plurality of core-shell nanoparticulate compositions being displayed on a metal oxide support under conditions effective to form H₂ and CO₂.

### Embodiment 28

A composition comprising a plurality of core-shell nanoparticles comprising late-transition-metal core encapsulated by metal oxide shell and displayed on a silica intermediate layer that is attached to a metal oxide support.

### Embodiment 29

A composition comprising a plurality of core-shell nanoparticles comprising late-transition-metal core encapsulated by metal oxide shell and displayed as a substantially single layer superposed on metal oxide support.

### Embodiment 30

The composition of Embodiment 28 or 29, the late-transition-metal core comprising at least one metal of Group 8, 9, 10, or 11.

### Embodiment 31

The composition of Embodiment 28 or 29, the late-transition-metal core comprising a noble metal.

### Embodiment 32

The composition of Embodiment 28 or 29, the late-transition-metal core comprising Ru, Co, Rh, Ir, Ni, Pd, Pt, Cu, Ag, Au, or a combination thereof.

### Embodiment 33

The composition of any one of Embodiments 28 to 32, the late-transition-metal core comprising Pd or Pt.

### Embodiment 34

The composition of any one of Embodiments 28 to 33, the late-transition-metal core having a diameter in the range of about 1 nm to about 10 nm.

### Embodiment 35

The composition of any one of Embodiments 28 to 34, the late-transition-metal core having a diameter of about 1 nm to about 5 nm.

### Embodiment 36

The composition of any one of Embodiments 28 to 35, the late-transition-metal core having a diameter of about 2 nm.

### Embodiment 37

The composition of any one of Embodiments 28 to 36, the metal oxide shell comprising at least one oxide of a metal of Group 3, 4, or 5.

### Embodiment 38

The composition of any one of Embodiments 28 to 36, the metal oxide shell comprising CeO₂, HfO₂, TiO₂, ZnO, ZrO₂, or a combination thereof.

### Embodiment 39

The composition of any one of Embodiments 28 to 38, the core-shell nanoparticles being arranged in a substantially single layer.

### Embodiment 40

The composition of any one of Embodiments 28 to 39, the metal oxide support comprising Al₂O₃.

### Embodiment 41

A fuel cell comprising the composition of any one of Embodiments 28 to 40.

### Embodiment 42

A method comprising:

contacting a hydrophilic metal oxide support with an organosilane to form a hydrophobic metal oxide support; and

contacting the hydrophobic metal oxide support with a plurality of core-shell nanoparticles comprising late-transition-metal core encapsulated by metal alkoxide shell to form a plurality of core-shell nanoparticles displayed on a siloxane intermediate layer that is attached to a metal oxide support.

### Embodiment 43

The method of Embodiment 42 further comprising dispersing the hydrophobic metal oxide support in solvent.

### Embodiment 44

The method of Embodiment 42 or 43, further comprising calcining the plurality of core-shell nanoparticles displayed on a siloxane intermediate layer that is attached to a metal oxide support to form a plurality of core-shell nanoparticles comprising late-transition-metal core encapsulated by metal oxide shell displayed on a silica layer that is attached to a metal oxide support.

### Embodiment 45

The method of any one of Embodiments 42 to 44, the organosilane comprising triethoxy(octyl)silane.

### Embodiment 46

The method of any one of Embodiments 42 to 45, the late-transition-metal core comprising Pd.

### Embodiment 47

The method of any one of Embodiments 42 to 46, the metal oxide shell comprising CeO₂.

### Embodiment 48

The method of any one of Embodiments 42 to 47, the hydrophilic metal oxide support comprising Al₂O₃.

### Embodiment 49

The method of any one of Embodiments 42 to 48, the late-transition-metal core comprising Pd, and the metal oxide shell comprising CeO₂.

### Embodiment 50

A method for catalyzing the combustion of a hydrocarbon comprising contacting said hydrocarbon with a plurality of core-shell nanoparticles comprising late-transition-metal core encapsulated by metal oxide shell and displayed on a silica intermediate layer that is attached to a metal oxide support, in the presence of O₂ under conditions sufficient to form H₂O and CO₂.

### Embodiment 51

A method for catalyzing the combustion of a hydrocarbon comprising contacting said hydrocarbon with a plurality of core-shell nanoparticles comprising late-transition-metal core encapsulated by metal oxide shell and displayed as a substantially single layer superposed on metal oxide support, in the presence of O₂ under conditions sufficient to form H₂O and CO₂.

### Embodiment 52

The method of Embodiment 50 or 51, the hydrocarbon comprising methane.

### Embodiment 53

The method of any one of Embodiments 50 to 52, the transition metal core comprising Pd.

### Embodiment 54

The method of any one of Embodiments 50 to 53, the metal oxide shell comprising CeO₂.

### Embodiment 55

The method of any one of Embodiments 50 to 54, the metal oxide support comprising Al₂O₃.

### Embodiment 56

The method of any one of Embodiments 50 to 55, the transition metal core comprising Pd, the metal oxide shell comprising CeO₂, and the metal oxide support comprising Al₂O₃.

### Embodiment 57

A method for catalyzing a water-gas shift reaction comprising contacting H₂O and CO with a plurality of core-shell nanoparticles comprising late-transition-metal core encapsulated by metal oxide shell and displayed on a silica intermediate layer that is attached to a metal oxide support, under conditions sufficient to form H₂ and CO₂.

### Embodiment 58

A method for catalyzing a water-gas shift reaction comprising: contacting H₂O and CO with a plurality of core-shell nanoparticles comprising late-transition-metal core encapsulated by metal oxide shell and displayed as a substantially single layer superposed on metal oxide support, under conditions sufficient to form H₂ and CO₂.

### Embodiment 59

The method of Embodiment 57 or 58, the transition metal core comprising Pd.

### Embodiment 60

The method of any one of Embodiments 57 to 59, the metal oxide shell comprising CeO₂.

### Embodiment 61

The method of any one of Embodiments 57 to 60, the metal oxide support comprising Al₂O₃.

### Embodiment 62

The method of any one of Embodiments 57 to 61, the transition metal core comprising Pd, the metal oxide shell comprising CeO₂, and the metal oxide support comprising Al₂O₃.

### Embodiment 63

A method for catalyzing a methanol reforming reaction comprising contacting H₂O and CH₃OH with a plurality of core-shell nanoparticles, said core-shell nanoparticles comprising late-transition-metal core encapsulated by metal oxide shell, the plurality of core-shell nanoparticles being displayed on a silica intermediate layer that is attached to a metal oxide support, under conditions sufficient to form H₂ and CO₂.

### Embodiment 64

A method for catalyzing a methanol reforming reaction comprising contacting H₂O and CH₃OH with a plurality of core-shell nanoparticles comprising late-transition-metal core encapsulated by metal oxide shell and displayed as a substantially single layer superposed on metal oxide support, in the presence of O₂ under conditions sufficient to form H₂ and CO₂.

### Embodiment 65

The method of Embodiment 63 or 64, the transition metal core comprising Pd.

### Embodiment 66

The method of any one of Embodiments 63 to 65, the metal oxide shell comprising CeO₂.

### Embodiment 67

The method of any one of Embodiments 63 to 66, the metal oxide support comprising Al₂O₃.

### Embodiment 68

The method of any one of Embodiments 63 to 67, the transition metal core comprising Pd, the metal oxide shell comprising CeO₂, and the metal oxide support comprising Al₂O₃.

### EXAMPLES

The following examples, while illustrative of individual embodiments, are not intended to limit the scope of the described invention, and the reader should not interpret them in this way.

### Example 1. Materials

Materials for Examples 1-7

Potassium tetrachloropalladate(II) (98%), potassium tetrachloroplatinate(II) (98%), 11-mercaptoundecanoic acid (MUA, 95%), zirconium(IV) butoxide solution (80 wt % in 1-butanol), and titanium(IV) butoxide (97%) were purchased from Sigma-Aldrich. Lithium triethylborohydride (LiBEt₃H in THF), dodecylamine (98%), and dodecanoic acid (99%) were purchased from Acros Organics. Tetraamminepalladium(II) nitrate was purchased from Strem Chemicals. Sodium borohydride (98%+), tetraoctylammonium bromide (TOABr, 98%+), and activated γ-Al₂O₃ (96%) were purchased from Alfa Aesar. Prior to use, y-Al₂O₃ was stabilized by calcining at 1023 K for 20 h and was determined to have a surface area of 150 m2 g-1 by performing Brunauer-Emmett-Teller measurements. All of the solvents used were HPLC grade from Fisher-scientific. Tetrahydrofuran was dried over activated 4 \acute{Å} molecular sieves prior to use.

Materials for Examples 8-11

Triethoxy(octyl)silane (TEOOS, ≥97.5%), tetraethyl orthosilicate (TEOS, ≥99.0%), Pd(NO₃)₂.2H₂O (40% as Pd), (NH₄)₂Ce(NO₃)₆ (99.99%), Fe(NO₃)₃.9H₂O (99.99%), tetramethylammonium hydroxide pentahydrate (TMAH, ≥97%), Pluronic P123 (average Mn 5800) were purchased from Sigma-Aldrich. Al₂O₃Puralox TH100/150 (90 m² g¹) was purchased from Sasol and calcined at 900° C. for 24 h. Pd@CeO₂ structures (at variable Pd/Ce weight ratios) were prepared according to the procedure described in detail elsewhere (18). Pd(1%)/CeO₂ IWI sample was prepared by incipient wetness impregnation of Pd onto a CeO₂ support according to a procedure described in detail elsewhere (30) and calcined at 850° C. for 5 hours using a heating ramp of 3° C. min⁻¹. All of the solvents were reagent grade from Sigma-Aldrich and were used as received.

### Example 2. Preparation of M@Oxide Nanoparticles

General Scheme for the Synthesis of Core-Shell Nanostructures

Without being bound by any particular theory, the general method for the preparation of the dispersible core-shell structures is shown in FIG. 4. These steps include the following: 1) the synthesis of thiolate-protected transition metal cores using an ω-carboxyl-bearing thiol as the passivating agent (11-mercaptoundecanoic acid, MUA); 2) the self-assembly of a metal alkoxide on the protected metal cores; 3) the partial protection of the alkoxy ligands by addition of dodecanoic acid to ensure final dispersibility of the structures; and 4) the controlled hydrolysis of the remaining alkoxy groups to obtain dispersible M@oxide nanostructures. See K. Bakhmutsky, N. L. Wieder, M. Cargnello, B. Galloway, P. Fornasiero, and R. J. Gorte, ChemSusChem, 2012, 5, 140-148, the entire content of which is incorporated herein by reference.

Preparation of Pt@TiO₂ Nanostructures

1.0 ml of a THF solution containing Pt nanoparticles (0.0193 mmol Pt) was added dropwise to a solution of Ti(OBu)₄ (0.144 g, 0.424 mmol) in THF (5 ml) while stirring vigorously, followed by addition of dodecanoic acid (1 mol vs. Ti). Hydrolysis of Ti(OBu)₄ was achieved by adding up to 0.5 ml of H₂O dissolved in THF dropwise over one day.

Preparation of Pt@ZrO₂ Nanostructures

1.0 mL of a THF solution containing Pt nanoparticles (0.0193 mmol Pt) was added dropwise to a solution of Zr(OBu)₄ (0.105 g, 0.275 mmol) in THF (5 ml) while stirring vigorously, followed by addition of dodecanoic acid (1 mol vs. Zr). Hydrolysis of Zr(OBu)₄ was achieved by adding up to 0.5 mL of H₂O dissolved in THF dropwise over one day.

Preparation of Pd@TiO₂ Nanostructures

The preparation of Pd@TiO₂ nanostructures containing 10 wt % Pd and 90 wt % TiO₂ was similar to a procedure reported elsewhere for Pd@CeO₂ nanostructures (M. Cargnello, N. L. Wieder, T. Montini, R. J. Gorte, P. Fornasiero, J. Am. Chem. Soc. 2010, 132, 1402-1409, the entire contents of which are incorporated herein by reference). The desired composition was achieved by adding a given volume of a standard solution of Pd nanoparticles to a solution containing the appropriate mass of Ti(OBu)₄. Typically, 7.0 ml of a THF solution containing Pd nanoparticles (0.064 mmol Pd) was added dropwise to a solution of Ti(OBu)₄ (0.263 g, 0.715 mmol) in THF (10 ml) while stirring vigorously, followed by addition of dodecanoic acid (1 mol vs. Ti). Hydrolysis of Ti(OBu)₄ was achieved by adding up to 0.5 ml of H₂O dissolved in THF dropwise over one day.

Preparation of Pd@ZrO₂ Nanostructures

4.0 mL of a THF solution containing Pd nanoparticles (0.0412 mmol Pd) was added dropwise to a solution of Zr(OBu)₄ (0.147 g 0.320 mmol) in THF (10 ml} while stirring vigorously, followed by addition of dodecanoic acid (1 mol vs. Zr). Hydrolysis of Zr(OBu)₄ was achieved by adding up to 0.5 ml of H₂O dissolved in THF dropwise over one day.

Preparation of Pd@ZnO and PI@ZnO Nanostructures

Pt@ZnO nanostructures were prepared and Pd@ZnO nanostructures may be prepared analogously to the methods provided in the preceding examples, except using zinc butoxide as the shell precursor. The Zn butoxide was prepared by reaction of diethyl zinc with anhydrous 1-butanol in a solution of toluene in a nitrogen-filled glovebox.

Characterization Techniques

Specimens for characterization of core-shell particles by transmission electron microscopy (TEM) were prepared by placing a drop of THF with dissolved particles onto a 200-mesh copper grid coated with a holey carbon film. TEM images were recorded by using a JEOL 2010 operated at 200 kV.

Samples for high angle annular dark field (HAADF) STEM and energy dispersive X-ray spectrometry (EDS) were prepared by placing a drop of sample dispersed in THF onto a 200-mesh copper grid coated with a holey carbon film. The images were recorded by using a JEOL 2010F high-resolution field-emission microscope, operating at 200 kV. HAADF images were captured with a 0.7 nm HR probe and a Gatan annular dark field detector with a collection angle of 54.9 mrad. EDS spectra were acquired by using a PGT PRISM Si(Li) (Princeton Gamma-Tech Instruments) detector with a thin window controlled by Quantax Espirit software.

### DISCUSSION

Preparation of MUA-functionalized Pt nanoparticles could not be performed through the same series of initial steps as preparation of MUA-functionalized Pd nanoparticles. This is due to the different reduction potentials of Pd(II) and Pt(II) moieties [E⁰(PdCl₄²⁻/Pd⁰)=0.62V, E⁰(PtCl₄²⁻/Pt⁰)=0.73V in acidic solution], with the former being much easier to reduce. In addition, the presence of thiol ligands may modify the reduction potentials, with the result that the Pt-thiol complex is not reduced by NaBH₄. Therefore, it was necessary to develop an alternative strategy for the preparation of MUA-Pt nanoparticles. Because our strategy for synthesis of dispersible core-shell structures requires a high-density of carboxyl groups on the surface of the nanoparticles, place-exchange reactions between alkyl and functionalized thiols cannot be used due to the low density of functionalities achievable with this method.

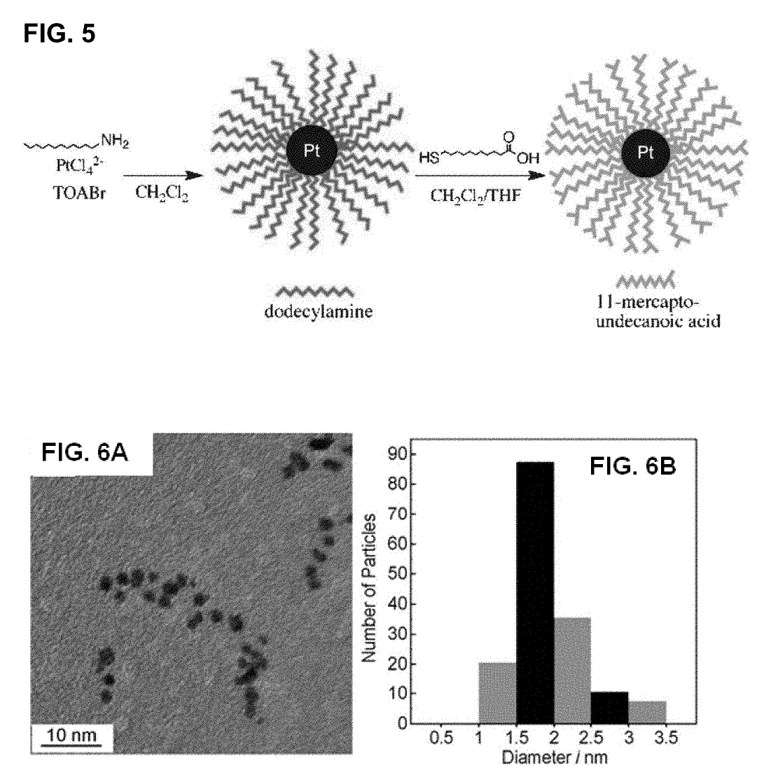

Reduction of Pt salts to form metallic Pt nanoparticles required a stronger reducing agent than NaBH₄; however, these stronger reducing agents are incompatible with carboxyl groups. Therefore, to avoid reduction of the carboxyl moiety or the unwanted acid-base side reaction, and without being bound by a particular theory, the strategy outlined in FIG. 5 was used for preparing Pt@oxide particles. This method involves synthesizing Pt particles, protected by an alkylamine ligand (dodecylamine) that is compatible with stronger reducing agents, using LiBEt₃H as the reducing agent, then replacing dodecylamine with MUA. Although it is typically difficult to achieve a high coverage of a desired ligand by exchanging one thiol for another, the dodecylamine was found to be efficiently displaced by the thiol due to the strong and favored Pt—S bond.

K₂PtCl₄ (0.300 g, 0.723 mmol) was dissolved in deionized water (3 mL). The PtCl₄²⁻ ion was then transferred into CH₂Cl₂ (30 ml) using TOABr (1.027 g, 1.879 mmol, 2.6 mol vs. Pt) as the phase-transfer agent. The phases were separated, the water layer discarded, and the organic layer was washed with brine and dried with magnesium sulfate. Dodecylamine (1.608 g, 8.672 mmol, 12 mol vs. Pt) was added, and the reaction vessel was flushed with N₂. 1.0 M LiBEt₃H in THF (5.8 ml, 8 mol vs. Pt) was rapidly added while stirring vigorously, after which the solution rapidly changed color from orange to an opaque, dark-brown/black. The reaction mixture was then stirred an additional 10 min, washed with water and then brine, and the solvent removed in vacuum. The resultant black solid was suspended in ethanol and sonicated, then centrifuged three times to remove excess dodecylamine and phase transfer agent. Finally, the black solid was redissolved in CH₂Cl₂ and filtered. TEM images of purified dodecylamine-Pt nanoparticles, shown in FIG. 6, indicated that the particles were small (<3 nm), with an average diameter of 2.0±0.3 nm. Initial attempts to produce Pt nanoparticles using a lower amine/Pt ratio (6 equivalents dodecylamine vs. Pt) failed and resulted in a product that was mostly an insoluble black solid following reduction. Initial attempts to reduce the ligand/PtCl₄²⁻ solution with NaBH₄ gave only a light brown, transparent solution with either MUA or dodecylamine as the ligand, suggesting incomplete reduction.

Carboxyl functionalities were introduced by place exchanging the amine ligand on dodecylamine-Pt particles with MUA. Replacement of the dododecylamine with 11-mercaptoundecanoic acid was accomplished by codissolving the dodecylamine-Pt nanoparticles and 11-mercaptoundecanoic acid (MUA) (1 mol vs. Pt) in a 3:1 CH₂Cl₂/THF solution. The solvent (3:1 ratio of CH₂Cl₂/THF) was chosen because of its ability to dissolve both, the starting dodecylamine-Pt particles and the produced MUA-Pt particles. The solution was stirred 18 h at room temperature. The product particles were purified by precipitation and washing with excess CH₂Cl₂. The solvent was removed in vacuum, and the resultant black solid was suspended in CH₂Cl₂ with sonication and centrifuged three times to remove excess dodecylamine. The black solid was then redissolved in THF and filtered.

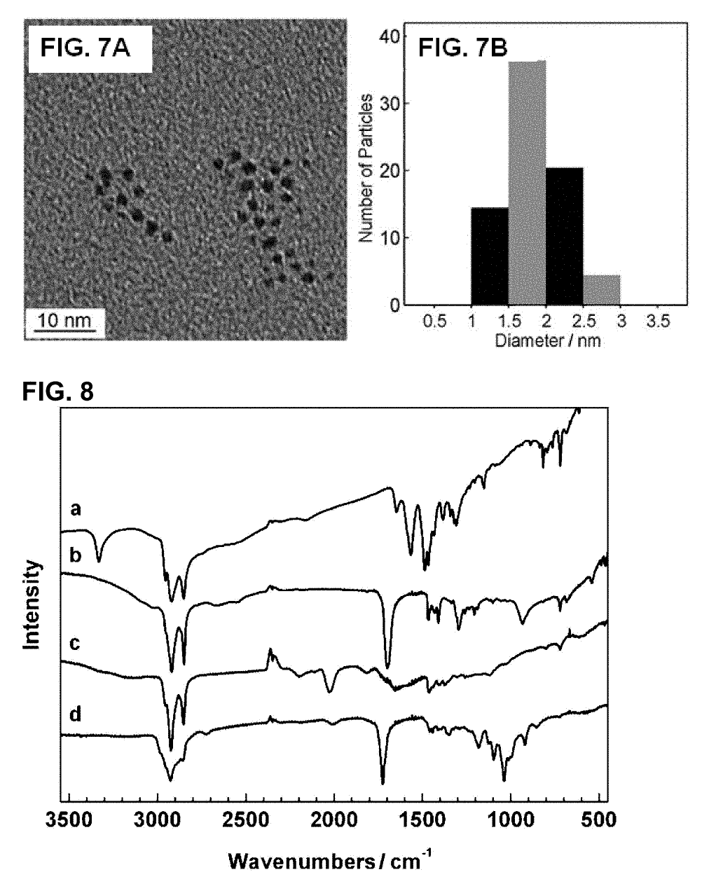

TEM images of the purified Pt particles acquired after place exchange are shown in FIG. 7 indicating that there was no change in particle dimensions or size distribution (σ=0.3 nm) compared to the dodecylamine-Pt particles. Notably, the parent dodecylamine-Pt particles are soluble in relatively non-polar solvents (CH₂CI₂, toluene, and alkanes), but are insoluble in more polar solvents such as THF, ethanol, and acetone. After place exchange with MUA, however, the particles are completely soluble in more polar solvents, and insoluble in CH₂Cl₂, suggesting that complete ligand exchange was successful.

The FTIR spectra of the ligands and nanoparticles in FIG. 8 provide further evidence for the complete exchange of MUA for dodecylamine. The absorption band at about 3330 cm⁻¹ corresponding to the ν(N—H) stretch in dodecylamine (FIG. 8A) is completely absent in the spectrum of dodecylamine-Pt nanoparticles (FIG. 8C), as observed previously for other amine-protected nanoparticles. Although a band for ν(N—H) bending remains, it has broadened and is centered at about 1654 cm⁻¹ on the particles. In the spectrum of MUA-protected Pt particles (FIG. 8B), the ν(N—H) bending mode is not present, and the spectrum does not exhibit any other obvious features for coordinated or free dodecylamine. As noted elsewhere for MUA-Pd particles, the very weak absorbance in the MUA spectrum at about 2546 cm⁻¹ for the ν (S—H) stretch is absent from the spectrum for the MUA-Pt particles, and the ν (C═O) stretching band is shifted from about 1697 cm⁻¹ for MUA to about 1726 cm⁻¹ for the MUA-Pt particles, indicating a different environment for the carboxyl groups in the monolayer.

The synthesis procedure for all the M@oxide, core-shell nanoparticles was similar and is exemplified by the synthesis of Pt@ZrO₂. The first step in Pt@ZrO₂ synthesis is the reaction between zirconium(IV) tetrakis(butoxide) and the carboxyl groups on the MUA-Pt nanoparticles. Without limiting to a particular theory, it may be that this reaction proceeds by displacement of a butoxy group on the ZrO₂ precursor with a carboxyl group on the surface of the Pt particle. This coupling is accomplished by dropwise addition of a Pt-nanoparticle solution to a zirconium-alkoxide solution under moisture-free conditions. The relative amounts of the MUA-Pt particle solution and the alkoxide were chosen such that the final product would be 10% Pd and 90% ZrO₂ by weight, but the procedure allows for the tuning of both metal and oxide content. Slow addition of the Pt-nanoparticle solution is necessary to ensure that the zirconium alkoxide remains in excess because the particles agglomerate and precipitate out of solution when alkoxide is added to a nanoparticle solution, presumably because carboxyls on different Pt particles bind to the same Zr^{IV} moiety. The coupling product is soluble in low-polarity solvents such as toluene and alkanes, whereas the precursor MUA-Pt particles are insoluble in such solvents, indicating that coupling between the hydrophobic ZrO₂ precursor and the Pt particles was successful. The final step to produce the oxide shell is the controlled hydrolysis of the alkoxide precursor in the presence of dodecanoic acid (1 mol vs. Zr). Without being limited to a particular theory, dodecanoic acid may serve the dual purpose of slowing hydrolysis and conferring solubility on the final product.

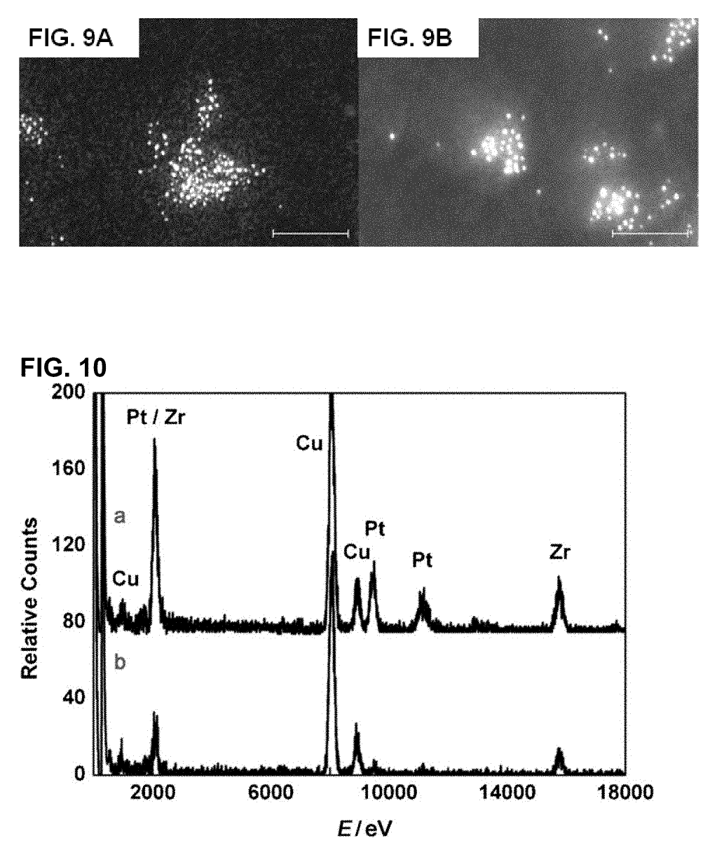

A high-angle annular dark field (HAADF) STEM image of a hydrolyzed solution of Pt@ZrO₂ (20 wt % Pt, 80 wt % ZrO₂) is shown in FIG. 9A. The contrast between the Pt core and the ZrO₂ shell is sufficient to distinguish the core-shell structure using this technique. The bright Pt cores, approximately 2 nm in diameter, are clearly visible in the image. The sizes of the Pt particles in FIG. 9A are the same as that in FIG. 7, which demonstrates that the treatments leading to the ZrO₂ shell have not altered the particle sizes. The Pt cores in FIG. 9A are surrounded by a brighter-than-background amorphous ZrO₂ film, which becomes more diffuse with distance from the Pt.

The energy-dispersive X-ray spectra (EDS) in FIG. 10 confirm that the bright cores and amorphous films are attributable to Pt and ZrO₂. The top spectrum in this Figure corresponds to the composition of a small rectangular box centered over a bright core-dense region, whereas the bottom spectrum has been taken from a rectangular box centered over a region containing only the lighter film. In the top spectrum, the strong peaks corresponding to Pt and Zr compounds confirm their presence, and the intensity difference between the bright cores and darker film confirms that they correspond to the Pt and Zr, respectively, due to their Z contrast. Additionally, the spectrum of a film area indicates only a weak presence of Zr.

Based on the relative positions of the particles in FIG. 9A, the general thickness of the ZrO₂ film in the Pt@ZrO₂ appears to be approximately 2-3 nm. This is considerably thinner than the shell thickness reported previously for Pd@CeO₂ nanostructures for which a CeO₂ layer of 5-10 nm was observed. Although the specific reasons for this difference are uncertain, it may be suggested that this may be due in part to a higher molecularity in the case of the cerium alkoxide (e.g., [Ce(OR)₄]ₙ, where n>1), as this could lead to a thicker oxide shell with CeO₂.

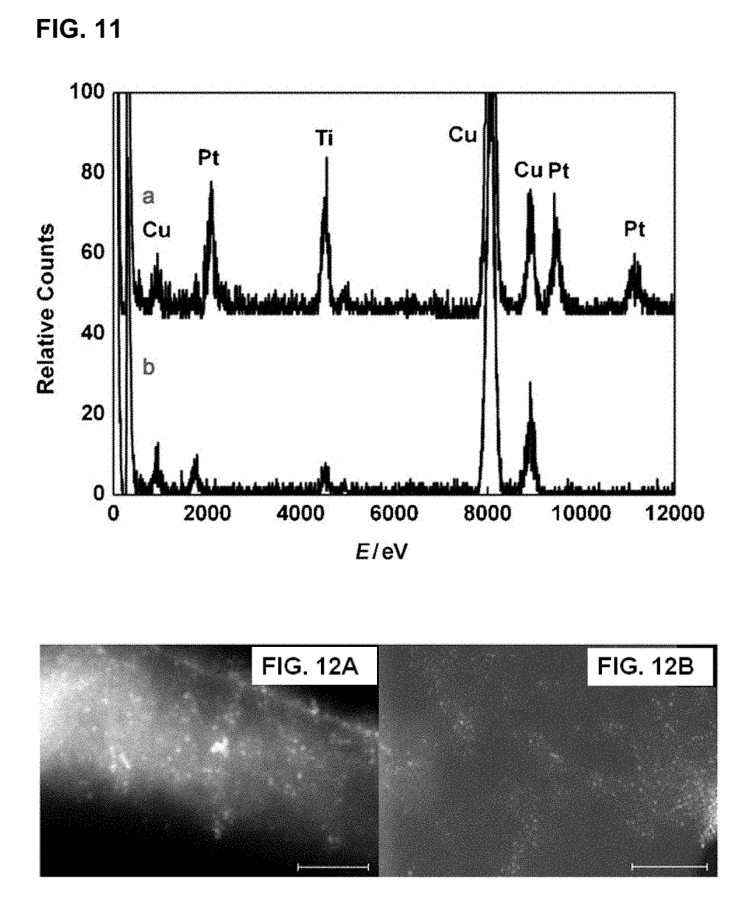

As discussed earlier, the procedure for synthesizing Pt@ZrO₂ could also be used to prepare Pt@TiO₂, with the only difference that titanium(IV) butoxide was used in place of zirconium(IV) butoxide. An HAADF STEM image of the hydrolyzed 20 wt % Pt 80 wt % TiO₂. Pt@TiO₂ assemblies is shown in FIG. 9B. Again, the bright Pt cores and the brighter-than-background amorphous TiO₂ film were observed. The compositions of the Pt cores and TiO₂ film were confirmed by recording an EDS spectrum of a rectangular box centered over the bright Pt core-dense region (FIG. 11A) and of a rectangular box centered over a dark-contrasted area (FIG. 11B). As before, the Pt cores were approximately 1-2 nm in diameter with an amorphous shell with a thickness of 2-4 nm.

Pd nanoparticles protected by MUA ligands were prepared similarly to the procedure reported elsewhere (M. Cargnello, N. L. Wieder, T. Montini, R. J. Gorte, P. Fornasiero, J. Am. Chem. Soc. 2010, 132, 1402-1409). Briefly, K₂PdCl₄ was dissolved in water and phase-transferred into a 1:1 acetone/dichloromethane solution using TOABr as the phase transfer agent. MUA (0.5 mol vs. Pd) was added, and the reaction mixture was reduced with excess NaBH₄. The resultant black precipitate was dissolved in acidified THF and filtered.

The synthesis of Pd@ZrO₂ and Pd@TiO₂ structures was similar to the Pt@oxide syntheses described above. A solution containing the MUA-Pd particles was slowly added to a solution containing zirconium(IV) butoxide or titanium(IV) butoxide, with controlled hydrolysis in the presence of dodecanoic acid leading to the Pd@ZrO₂ and Pd@TiO₂ products. HAADF STEM images of the Pd@ZrO₂ and Pd@TiO₂ structures are shown in FIG. 12 and again indicate the presence of bright metallic cores, approximately 2 nm in diameter, with a surrounding film. The Pd@TiO₂ structures were analyzed by EDS (not shown) and the results showed that the bright cores were associated with Pd, whereas the film was TiO₂.

### Example 3. Accessibility of M@Oxide Nanoparticles

CO Adsorption on M@Oxide Nanostructures

For M@oxide particles to be useful for catalysis, the metal core needs to be accessible to reactants. To determine this accessibility, the properties of the samples for adsorption of gas-phase CO were examined. To prevent formation of agglomerates and ensure that the M@oxide particles would be accessible to reactants, the dissolved nanoparticles were first dispersed on a high-surface-area Al₂O₃ and calcined in air to remove functionalized precursors. Diffuse reflectance infrared Fourier transform spectroscopy (DRIFTS) measurements were used as the primary technique for measuring adsorption because the frequency of the ν(C═O) stretch of adsorbed CO is very distinctive to the surface on which it is adsorbed. Because high-temperature reduction can result in a loss in the ability of Pd to adsorb CO, the reduction conditions in the present study were carefully controlled. Low-temperature reduction was accomplished by first oxidizing the catalysts in air at 623 K, then reducing them in 10% H_{2/90}% He at 423 K before exposure to CO at room temperature.

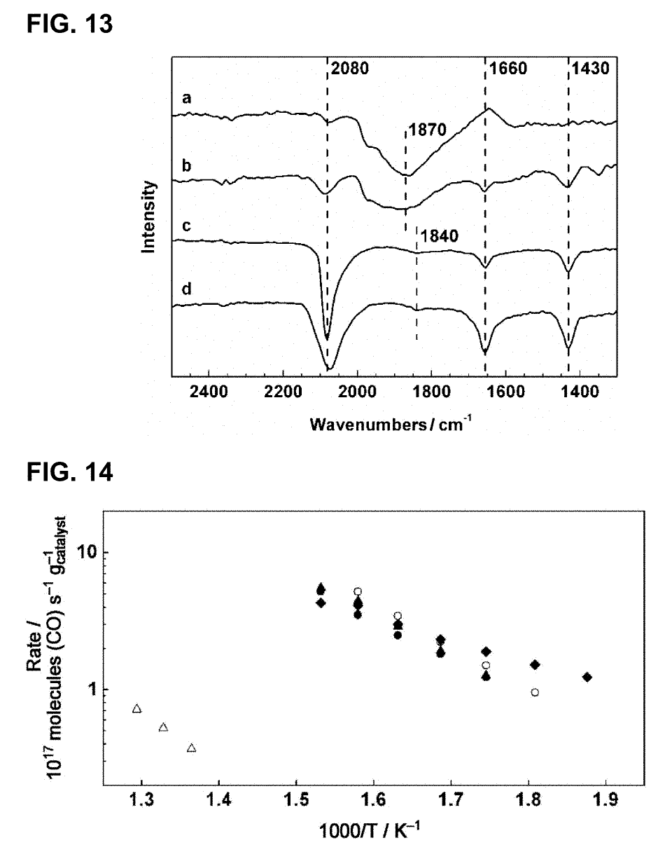

DRIFTS spectra following CO adsorption on representative Al₂O₃-supported samples are shown in FIG. 13. The absence of bands near ν=2143 cm⁻¹ confirms that gas-phase CO is not present in significant amounts. Spectra for 1 wt % Pd@9 wt % TiO₂/Al₂O₃ and 1 wt % Pd@9 wt % ZrO₂/Al₂O₃ samples in FIGS. 13A and B exhibit a broad band for ν(C═O) stretching between about 1800 and about 1950 cm⁻¹, associated with bridge-bound CO in various environments, and a small peak at about 2080 cm⁻¹, associated with linearly bound CO. The spectra for 1 wt % Pt@9 wt % TiO₂/Al₂O₃ and 1 wt % Pt@9 wt % ZrO₂/Al₂O₃ samples, in FIGS. 13c and d, show the linearly bound CO at about 2080 cm⁻¹ and the bridge-bound species at about 1840 cm⁻¹ in addition to the carbonate species bands. Notably, the spectra in FIG. 13 are typical of those reported on normal supported Pt and Pd catalysts, with CO populating primarily linear, on-top sites for Pt and bridged sites for Pd. The results clearly indicate that CO adsorbs on the Pt and Pd cores.

Diffuse reflectance Fourier transform infrared (DRIFTS) and FTIR spectra were obtained by using a Mattson Galaxy 2020 FTIR spectrometer. The spectrometer was equipped with a Spectra-Tech Collector II diffuse-reflectance accessory to allow measurements on powdered samples, with control over temperature and atmosphere. To produce samples reduced at lower temperatures, the catalysts were first heated to 673 K while being exposed to a flowing mixture of 10% O₂/90% He for 20 min, then the samples were cooled to 423 K in flowing He. At 423 K, the samples were reduced under a 10% H/90% He mixture for 20 min before flushing with He, after which the samples were cooled to room temperature. The samples were then exposed to a 10% CO/90% He mixture for 5 min and flushed with He until the gas-phase band of CO was no longer observed in the DRIFTS results. Spectra of the samples were acquired at room temperature under He flow.

To quantify the adsorption uptakes, volumetric adsorption measurements were performed on the samples after they had been oxidized and reduced under conditions that were identical to those used in the DRIFTS measurements. The results for these experiments are shown in Table 1. All catalysts exhibited reasonable CO uptakes, with calculated dispersions ranging from 6-18%, suggesting again that the metal core is accessible to CO, at least after mild reduction. Obviously, the dispersions are significantly lower than would be observed for a normal Pd/Al₂O₃ catalyst with a similar Pd crystallite size due to the presence of the oxide shell.

TABLE 1
CO chemisorption on Pd/Pt-promoted materials used in this study

| Sample | Pd/Pt dispersion [%] |
|---|---|
| 1 wt % Pd/Al₂O₃ | 32 |
| 1 wt % Pd@9 wt % CeO₂/Al₂O₃ | 10 |
| 1 wt % Pd@9 wt % TiO₂/Al₂O₃ | 16 |
| 1 wt % Pd@9 wt % ZrO₂/Al₂O₃ | 17 |
| 1 wt % Pt@9 wt % CeO₂/Al₂O₃ | 6 |
| 1 wt % Pt@9 wt % TiO₂/Al₂O₃ | 17 |
| 1 wt % Pt@9 wt % ZrO₂/Al₂O₃ | 18 |

### Example 4. Preparation of Al₂O₃-Supported M@Oxide Catalysts

An appropriate mass of γ-Al₂O₃ was added to the dissolved M@oxide particles in THF to achieve a loading of 1 wt % metal and 9 wt % oxide. After the mixture was stirred for 2 h, THF was removed by evacuation. For comparison purposes, experiments were also conducted on conventional 1 wt % Pd/Al₂O₃ and 9.09 wt % CeO₂/Al₂O₃ catalysts. The 1 wt % Pd/Al₂O₃ sample was prepared by incipient wetness impregnation of (NH₃)₄Pd(NO₃)₂ onto the γ-Al₂O₃ support. The 9.09 wt % CeO₂/Al₂O₃ catalyst was prepared by slowly hydrolyzing cerium(IV) alkoxide in a stirred solution of 1 g of γ-Al₂O₃ in 2 mL of THF. All of the resulting powders were then dried at 338 K overnight. Before any testing, the powders were crushed with a mortar and pestle and subsequently calcined in air at 773 K for 4 h.

### Example 5. Characterization of Al₂O₃-Supported M@Oxide Catalysts

The metal dispersions of the Al₂O₃-supported catalysts were determined by CO chemisorption. Samples were first oxidized at 673 K in 26.7 kPa (200 Ton) of O₂ for approximately 5 min, evacuated, and then reoxidized. This procedure was repeated three times. The sample was then cooled to 423 K and exposed to 26.7 kPa (200 Torr) of H₂ for 5 min, evacuated, and then re-reduced. This procedure was also repeated three times. After evacuation, CO chemisorption was performed at room temperature by adding small aliquots of CO to the sample until there was a rise in the pressure above the sample. Total surface areas were determined by measuring N₂ Brunauer-Emmett-Teller isotherms at liquid nitrogen temperature.

### Example 6. M@Oxide/Al₂O₃Catalytic Tests

Rates for the water-gas-shift (WGS) reaction were measured in a tubular reactor with 0.1 g of an Al₂O₃-supported catalyst. All rate measurements were collected at partial pressures of 3.33 kPa (25 Torr) of both CO and H₂O. Water was introduced to the reactor by saturating a He gas flowing through a deionized water saturator, and the partial pressures of each gas-phase component were controlled by adjusting the relative flow rates. The total flow rate of gas was maintained at 120 mL min′. Prior to measuring the rates, each sample was heated to 673 K under flowing He and reduced in a 10% H/90% He mixture for 30 min. The samples were then cooled to the reaction temperature under flowing He. The conversions of CO and H₂O were kept below 10% so that differential conditions could be assumed. The concentration of the effluent from the reactor was determined by using an on-line gas chromatograph SRI Model 8610C, equipped with a HayeSep-D column and a thermal conductivity detector. Transients in the WGS reaction rates were monitored at 673 K. Before analyzing the products, all samples were heated to 673 K under flowing He and reduced. in a 10% H/90% He mixture for 30 min. The conversions of CO and H₂O in these experiments were not differential, but were kept below 35% to distinguish between samples.

Steady-state water-gas shift (WGS) reaction rates at 3.33 kPa (25 Torr) CO and H₂O are reported in FIG. 14 for Al₂O₃-supported core-shell catalysts containing 1 wt % Pd and 9 wt % of the oxide. These rates are also compared to a traditional 1 wt % Pd/Al₂O₃ catalyst and an about 9 wt % CeO₂/Al₂O₃ catalyst. Before measuring these rates, the catalysts were reduced in 10% H₂/90% He at 673 K. This higher reduction temperature was used because a previous study with Pd@CeO₂ catalysts showed rapid deactivation of the catalyst as it was reduced by the WGS environment. Even with this higher reduction temperature, the initial rates with the Pd@oxide catalysts were significantly higher than those shown in FIG. 14, but decreased under reaction conditions, which will be discussed later. The steady-state activities of Pd@CeO₂/Al₂O₃, Pd@TiO₂/Al₂O₃, and Pd@ZrO₂/Al₂O₃ (10-17% dispersion) were similar to that of the better dispersed, 1 wt % Pd/Al₂O₃ catalyst. CeO₂/Al₂O₃, prepared by using the same precursors as for the synthesis of Pd@CeO₂/Al₂O₃, but without the MUA-Pd cores, was essentially inactive. Again, this confirms the accessibility of the precious-metal core to reactant molecules. Because the dispersions on the core-shell catalysts were lower, some activity enhancement was observed in the core-shell catalysts.

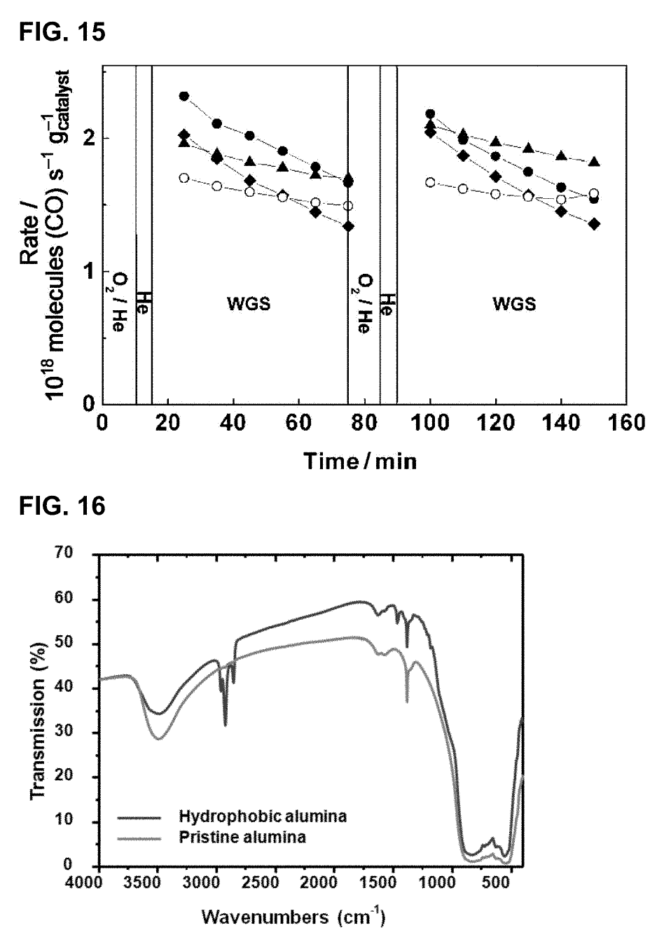

The transient deactivation of the core-shell catalysts was also examined under WGS conditions, with rates shown as a function of time in FIG. 15. Each of the catalysts were initially exposed to 10% O₂/90% He flow at 673 K, flushed with He, and then exposed to the WGS reaction conditions. After measuring the rates for 1 h, the catalysts were again oxidized and the entire procedure repeated. The Pd@CeO₂/Al₂O₃ and Pd@TiO₂/Al₂O₃ catalysts showed significant deactivation over the period of 1 h, similar to what was reported for Pd@CeO₂/Al₂O₃ in a previous study. In that case, it was shown that the loss in catalytic activity was accompanied by a loss in CO adsorption capacity, which was believed to be due to reduced CeO₂ covering the Pd surface. Activity and adsorption capacity were restored following oxidation of the catalyst. Although TiO₂ is not reducible in the same way as CeO₂, loss of chemisorption properties following high temperature reduction of TiO₂-supported catalysis is a well-known phenomenon, frequently referred to as strong metal support interactions (SMSI).

Interestingly, the deactivation of Pt@CeO₂/Al₂O₃ and Pt@TiO₂/Al₂O₃ was also less pronounced than that of the Pd analogs. For example, if deactivation is due to loss of adsorption capacity in Pd@CeO₂/Al₂O₃, the loss in Pt@CeO₂/Al₂O₃ adsorption capacity is anticipated to be much less, possibly due to differences in the way in which CeO₂ interacts with these two metals. To test this idea, CO adsorption uptakes on the Pd@CeO₂/Al₂O₃ and Pt@CeO₂/Al₂O₃ catalysts were measured after increasing the reduction temperature to 673 K prior to chemisorption of CO at room temperature. After increasing the reduction temperature from 423 to 673 K, the dispersion of the Pd@CeO₂/Al₂O₃ catalyst decreased significantly from 12 to 5% (Table 2), comparable to our findings from our previous study, in which dispersion of a similar sample decreased from 11% to negligible CO adsorption. Reoxidizing the Pd@CeO₂/Al₂O₃ catalyst and reducing at 423 K again decreased the dispersion slightly to 10%, suggesting that the oxidizing treatment can partially restore the initial dispersion. However, for Pt@CeO₂/Al₂O₃, there was no loss in CO uptake upon increasing the reduction temperature; rather, than calculated dispersion actually increased slightly from 6 to 8%. Oxidizing the Pt@CeO₂/Al₂O₃ catalyst again and reducing at 423 K restored the initial metal dispersion, suggesting that Pt@CeO₂/Al₂O₃ is considerably less susceptible to deactivation following the reduction-oxidation treatment. The interaction between the different metals and the reducible shells certainly appears to be an important factor in affecting the stability of the core-shell catalysts.

TABLE 2
Metal dispersion based on CO uptake at room temperature for the same
sample after successively varying the H₂ reduction temperature.

| | 1^{st} Reduction | 2^{nd} Reduction | 3^{rd} Reduction |
|---|---|---|---|
| Sample | at 423 K | at 673 K | at 423 K |
| 1 wt % Pd@9% wt % | 12 | 5 | 10 |
| CeO₂/Al₂O₃ | | | |
| 1 wt % Pt@9% wt % | 6 | 8 | 6 |
| CeO₂/Al₂O₃ | | | |
| 1 wt % Pd@9% wt % | 18 | 11 | 17 |
| ZrO₂/Al₂O₃ | | | |
| 1 wt % Pt@9% wt % | 18 | 14 | 19 |
| ZrO₂/Al₂O₃ | | | |

The transient deactivation for Pd@ZrO₂/Al₂O₃ and Pt@ZrO₂/Al₂O₃ is also noteworthy, as it was considerably less steep compared to Pd@CeO₂/Al₂O₃ and Pd@TiO₂/Al₂O₃, which is probably due to the fact that ZrO₂ is considerably less susceptible to reduction. However, measuring CO adsorption uptakes on Pd@ZrO₂/Al₂O₃ after increasing the reduction temperature from 423 to 673 K decreased the dispersion from 18 to 11%. A slightly smaller decrease was observed for a similar procedure on Pt@ZrO₂/Al₂O₃, with dispersion decreasing from 18 to 14%. In both catalysts, oxidizing treatments restored most of the initial dispersion, to 17 and 19% for Pd@ZrO₂/Al₂O₃ and Pt@ZrO₂/Al₂O₃, respectively. Despite the decreases in CO uptake at higher reduction temperatures, the deactivation for both catalysts was less than that observed with Pd@CeO₂/Al₂O₃ and Pd@TiO₂/Al₂O₃. This suggests that the chemisorption is suppressed upon a higher reduction treatment, possibly due to the layering of ZrO₂ on Pt as part of SMSI. Similarly, oxidizing treatment restores chemisorption ability in SMSI-affected metals as exhibited with ZrO₂-based core-shell catalysts. However, during WGS reactions, it appears that the SMSI conditions are absent, a little transient deactivation is observed.

### Example 7. Adsorption of Pd@CeO₂ Particles onto Pristine Al₂O₃

The appropriate amount of Pd@CeO₂ structures was added to the pristine alumina well dispersed in THF (15 mL). Although the mixture was left stirring overnight, not all the structures were adsorbed. Solvent was then removed by rotary evaporation, and the solid residue was dried at 120° C. overnight, ground to a particle size below 150 μm and calcined in air at 850° C. for 5 hours using a heating ramp of 3° C. min⁻¹.

### Example 8. Preparation of Hydrophobic Al₂O₃(H—Al₂O₃)

In a typical synthesis, dry alumina powder (1 g) was sonicated in 20 mL of toluene followed by addition of TEOOS (0.55 mL). The resulting solution was refluxed for 3 hours and the precipitate powder was recovered by centrifugation (4500 rpm). The powder was subsequently washed twice with toluene to remove unreacted TEOOS and byproducts and was dried overnight at 120° C.

### Example 9. Adsorption of Pd@CeO₂ Particles onto Hydrophobic Al₂O₃

The appropriate amount of Pd@CeO₂ structures was added to the hydrophobic alumina well dispersed in THF (15 mL). Although a complete adsorption occurred almost immediately when using loadings of Pd and ceria of 1 and 9-wt. % or less, respectively, the mixture was left stirring overnight. The solid residue was recovered by centrifugation (4500 rpm for 15 minutes) and washed twice with THF. Finally, the powder was dried at 120° C. overnight, ground to a particle size below 150 μm and calcined in air at 850° C. for 5 hours using a heating ramp of 3° C. min⁻¹. See M. Cargnello, J. J. Delgado Jaén, J. C. Hernández Garrido, K. Bakhmutsky, T. Montini, J. J. Calvino Gámez, R. J. Gorte, and P. Fornasiero, Science, 2012, 337, 713-717, the entire content of which is incorporated herein by reference.

The alumina surface was first made hydrophobic by reacting it with an organosilane, triethoxy(octyl)silane (TEOOS) (FIG. 2B). Without limiting to a particular theory, it may be that because this silane has three alkoxy groups that are prone to hydrolysis and one alkyl chain which is not, the reaction between the silane and alumina can lead to one of two situations. Either the silanol groups formed by hydrolysis of the ethoxy ligands can react with OH groups of the alumina surface to form oxane bonds of the type Si—O—Al or the silane molecules can react with each other to give multimolecular structures of bound silanes on the surface. In either case, the strong Si—C bond ensures that the alkyl chain is attached to Si moieties, causing the surface of alumina to be covered by alkyl chains. The presence of Si can also be of benefit for the reducibility of the supported ceria. The efficiency of the adopted strategy was demonstrated by pouring water droplets on a powdery layer of both pristine and hydrophobic alumina. The water droplets deposited on the pristine alumina immediately spread on the powder as a consequence of the favorable interactions with the alumina OH groups. On the contrary, the water droplets deposited on the hydrophobic alumina are immediately repulsed. Fourier-Transform Infrared (FT-IR) analysis confirm the occurrence of alkyl chain attachment onto the surface of alumina. FT-IR spectra of pristine alumina and hydrophobic alumina show C—H stretching bands of methylene and methyl groups in the region of about 3000-2800 cm⁻¹ lin the case of hydrophobic alumina but not in the case of pristine alumina (FIG. 16).

Preparation of Hydrophobic Mesoporous Fe₂O₃ and SiO₂ Samples and Adsorption of Pd@CeO₂ Structures

Mesoporous SiO₂ with an average pore size of 4 nm was synthesized according to the procedure of Zhao et al. (D. Zhao, Q. Huo, J. Feng, B. F. Chmelka, G. D. Stucky, J. Am. Chem. Soc. 120, 6024 (1998), the entire contents of which are incorporated herein by reference). Hydrophobation and adsorption of Pd@CeO₂ structures was conducted as reported above for alumina.

Mesoporous Fe₂O₃ was synthesized by precipitation. Fe(NO₃)₃.9H₂O (15 g) was dissolved in 150 mL of methanol and a solution of tetramethylammonium hydroxide (20 g in 50 mL of methanol) was dropwise added. The precipitate was left stirring for 1 hour, filtered, washed with water, dried at 120° C. overnight and calcined at 500° C. for 5 hours. Hydrophobation and adsorption of Pd@CeO₂ structures was conducted as reported above for alumina.

Characterization Techniques

Powder X-ray diffraction patterns were collected on a Philips PW 1710/01 instrument with Cu Kα radiation (graphite monochromator). Diffraction patterns were taken with a 0.02 degree step size, using a counting time of 10 s per point.

FT-IR spectra were recorded on a Perkin-Elmer FT-IR/Raman 2000 instrument in the transmission mode; samples were prepared as KBr disks (by mixing samples with spectroscopic grade KBr) and analyzed in the 400-4000 cm-1 range.

HRTEM images were recorded on a JEOL2010-F microscope with 0.19 nm spatial resolution under Scherzer defocus conditions. HAADF-STEM images were obtained by using an electron probe of 0.5 nm of diameter at a diffraction camera length of 10 cm. Tomography experiments based on high-angle annular dark-field (HAADF) imaging in the scanning transmission electron microscopy (STEM) mode were performed on the same electron microscope tilting the sample about a single axis using a Fischione Ultra-Narrow Gap Tomography Holder. Tilt series were aligned and reconstructed using Inspect3D software (FEI, The Netherlands) and AMIRA software was used for visualization.

Results and Discussion

The supramolecular Pd@CeO₂ core-shell structures were prepared according to Cargnello et al. (M. Cargnello, N. L. Wieder, T. Montini, R. J. Gorte, P. Fornasiero, J. Am. Chem. Soc. 2010, 132, 1402-1409, the entire contents of which are incorporated herein by reference). This method is based on the self-assembly between functionalized metallic Pd particles (˜2 nm) protected by 11-mercaptoundecanoic acid (MUA) and a Ce(IV) alkoxide. It takes advantage of a strategic combination of interactions, the first of which occurs between the thiol group of MUA and Pd, while the second one is between the carboxyl group of the MUA and Ce(IV) moieties. A controlled hydrolysis in the presence of dodecanoic acid of the resulting assembled units leads to the formation of the Pd@CeO₂ structures, where the CeO₂ shell is composed of small crystallites (˜3 nm) organized around the preformed Pd particles. The structures are dispersible in common low-polarity solvents such as tetrahydrofuran, dichloromethane, toluene and other hydrocarbons and are amenable for controlled deposition onto different substrates. Furthermore, the extension of this procedure to other core-shell compositions (Pd and Pt as core, TiO₂, ZrO₂ and CeO₂ as shells) gives to the present approach a wide applicability and versatility.

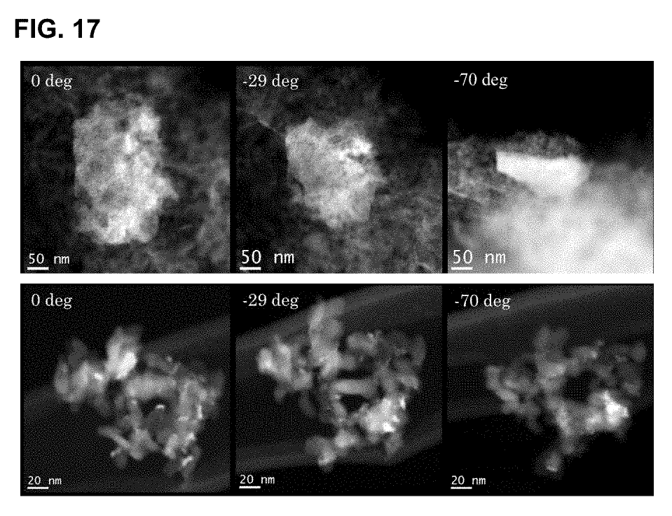

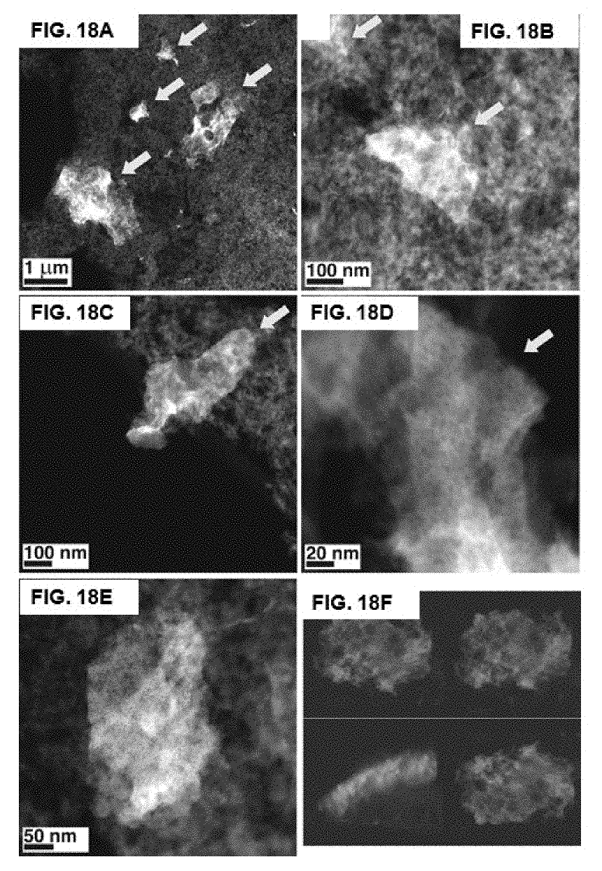

That Pd@CeO₂ structures can be deposited onto pristine, commercial alumina, resulting in redox properties and catalytic performances different from those of conventional or bulk materials has been demonstrated. However, since pristine alumina is highly hydrophilic, minimal interactions were observed between the alumina support and the hydrophobic Pd@CeO₂ structures, so that the Pd@CeO₂ structures tended to agglomerate with one another rather than adhering to the support (FIG. 2A). This agglomeration was confirmed by high-angle annular dark field (HAADF)—scanning transmission electron microscopy (STEM) images collected at different tilting angles (FIGS. 17 and 18). The active phase agglomeration may introduce the generation of hot spots and deactivate the catalyst by sintering, so it was crucial to develop a synthetic strategy able to deposit the Pd@CeO₂ as single units on the support.

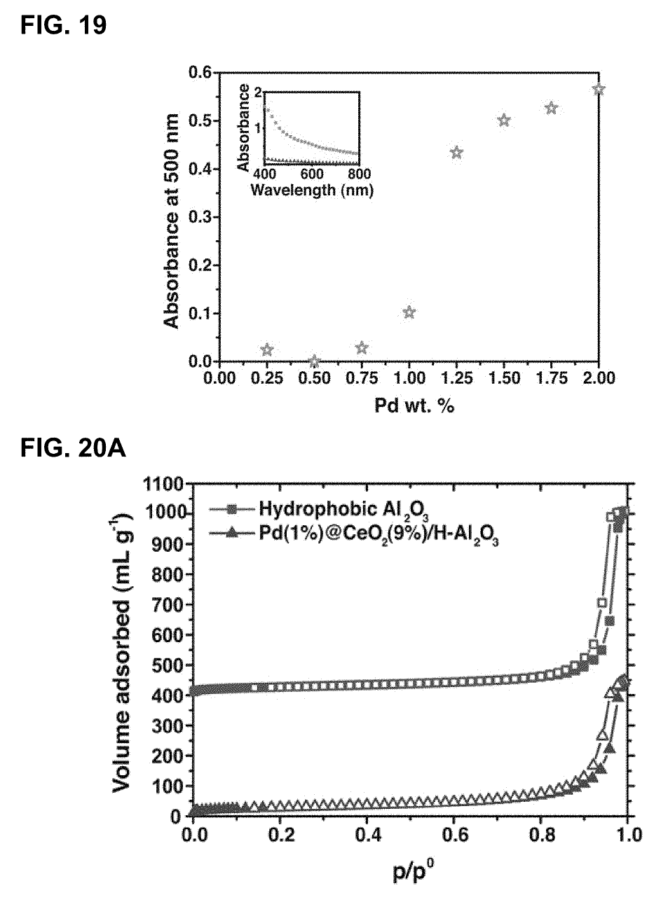

Hydrophobic Al₂O₃ (referred to herein as H—Al₂O₃) shows a remarkably greater capacity for the adsorption of the Pd@CeO₂ structures compared to the pristine, hydrophilic Al₂O₃. The adsorption resulted in a color change of the supernatant solution, which was almost colorless when adsorbed onto hydrophobic alumina but dark when adsorbed onto pristine alumina. The difference in adsorption is illustrated by comparison of three supernatant solutions after adsorption of Pd@CeO₂ structures and centrifugation: Tube A) 1.00-wt % Pd@CeO₂ on hydrophobic Al₂O₃; Tube B) 1.00-wt % Pd@CeO₂ on pristine, hydrophilic Al₂O₃, and Tube C) dispersed equivalent amount of Pd@CeO₂ (FIG. 19). Tube A demonstrates the qualitative takeup of Pd@CeO₂ structures using the two routes: Pd@CeO₂ structures are adsorbed onto the surface of the hydrophobic alumina support, leading to a dark Al₂O₃ powder and leaving behind an almost colorless solution, demonstrating that the entire amount of structures was adsorbed. By contrast, Tube B demonstrates the qualitative takeup of Pd@CeO₂ structures using the pristine alumina: few Pd@CeO₂ structures are adsorbed onto the surface of the hydrophilic pristine alumina support, leading to a slightly darkened Al₂O₃ powder and leaving behind a brown supernatant. Tube C is the control tube, consisting only of Pd@CeO₂ structures dispersed in THF. In all three instances, the total amount of Pd@CeO₂ is held constant, and the weight ratio of Pd to CeO₂ is 1:9. Comparing Tube B and C, it is evident that the use of pristine alumina leaves most of the Pd@CeO₂ structures in solution rather than dispersing it onto the support as in Tube A.

To quantitatively measure the adsorption of Pd@CeO₂ structures on H—Al₂O₃, the absorbance were measured at 500 nm for a solution of Pd@CeO₂ after the addition of varying amounts of H—Al₂O₃. Because the solution of Pd@CeO₂ structures shows a broad absorption band in the UV-Vis region (the Pd to CeO₂ weight ratio was fixed at 1:9), the concentration of Pd@CeO₂ structures remaining in solution can be inferred from the intensity of the absorption. The absorbance of the supernatant versus loading curve shows a characteristic sigmoidal shape, with a sharp increase for loadings greater than 1-wt. %, indicating the H-Al₂O₃ surface becomes saturated at coverages higher than this. Remarkably, this loading is approximately half of that expected for a theoretical monolayer, assuming the Pd@CeO₂ structures pack in a close-packed configuration over the entire available surface area. The occurrence of the maximum Pd@CeO₂ adsorption capability by hydrophobic alumina corresponds to a weight loading of Pd 1% and CeO₂ 9%. Considering 1 g of the catalyst, this translates into a Pd@CeO₂/H-Al₂O₃ composition of 1%, 9% and 90%, so that 10 mg of Pd are present, corresponding to 9.4·10⁻⁵ mol of Pd. Assuming a Pd particle size of 2 nm, this corresponds to a number of Pd atoms of ˜400. Therefore, the number of Pd@CeO₂ structures is 1.4·10¹⁷. The average diameter in solution of the single structures is 20 nm, which corresponds to a cross sectional area of ˜310 nm², or 3.1·10⁻¹⁶ m². The total area occupied by the Pd@CeO₂ structures is ˜43 m². Given that the alumina surface area is 81 m², the surface area occupied by the structures is roughly half of that available on the alumina carrier.

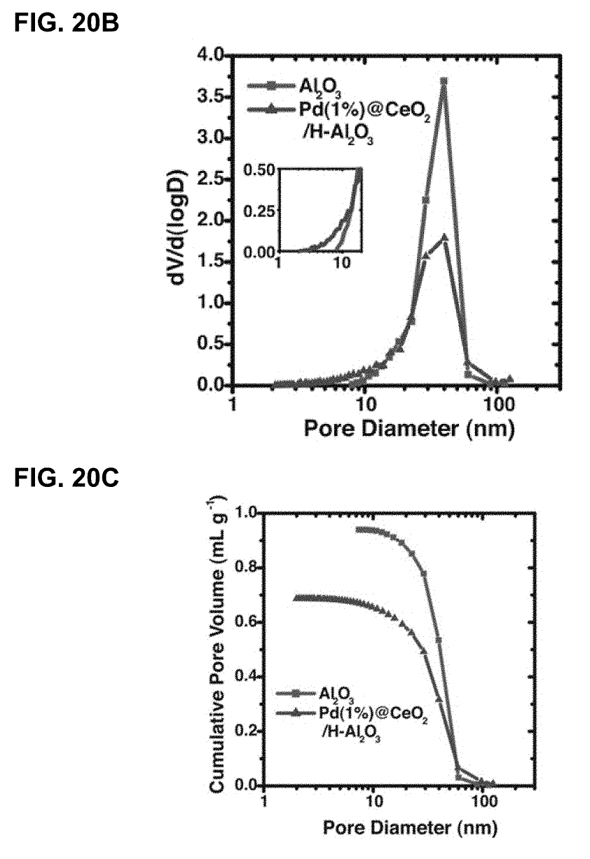

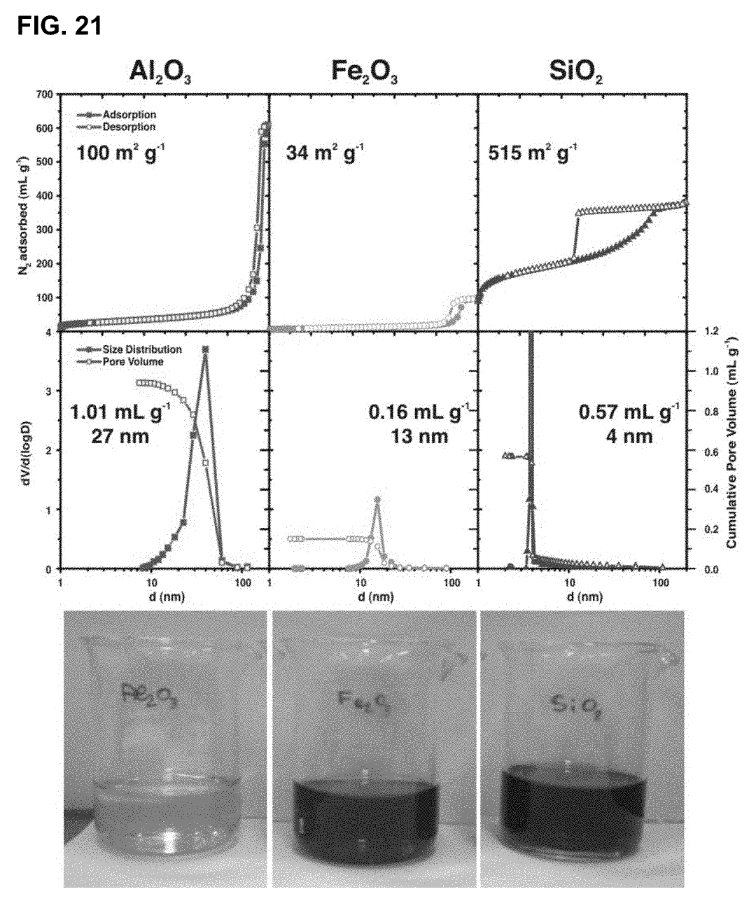

Without limiting to a particular theory, the fact that the maximum loading of Pd@CeO₂ is only half the theoretical is likely because only one-half of the surface area of the H-Al₂O₃ is associated with mesopores that have a diameter smaller than that of the Pd@CeO₂ units, ˜15 nm in dimension as prepared, preventing these pores from contributing to the adsorption process (FIG. 20). The deposition of Pd@CeO₂ onto H-Al₂O₃ also leads to the formation of pores with diameters smaller than 10 nm that were not present in the original H—Al₂O₃(FIG. 20). These pores could be associated with the Pd@CeO₂ units themselves. The porous nature of the CeO₂ shell is corroborated by CO chemisorption data (see below), which demonstrates the accessibility of Pd. The requirement of having the proper pore sizes for deposition of Pd@CeO₂ onto the alumina was further demonstrated by our attempts to deposit these structures onto hydrophobic Fe₂O₃ and SiO₂ samples, materials with narrow pore-size distributions but smaller pore size than Al₂O₃(FIG. 21). With both hydrophobic Fe₂O₃ that had an average pore diameter of 13 nm and SiO₂ that had an average pore diameter of 4 nm, very little adsorption of the Pd@CeO₂ structures was observed, despite the very high surface area in the SiO₂ support.

Several electron microscopy techniques were used to demonstrate that single Pd@CeO₂ supramolecular structures were successfully deposited onto the hydrophobic alumina (FIG. 3).

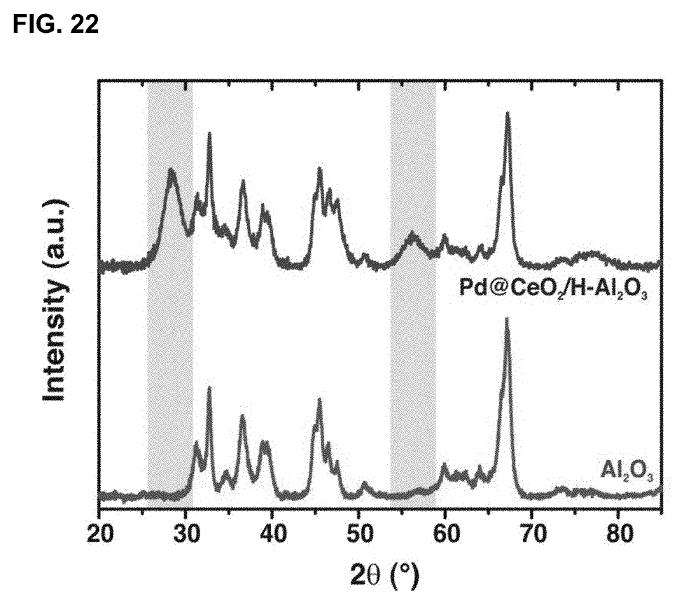

HAADF-STEM images (FIGS. 3A, B, and D) show Pd@CeO₂ as small bright spots on the underlying surface of the hydrophobic alumina crystallites. The Pd@CeO₂ units are well dispersed and well separated throughout the entire supporting material. Images collected at different tilting angles confirmed that the structures were indeed single units (FIG. 17). X-Ray Energy Dispersive Spectroscopy (EDS) analysis with a very fine probe (0.5 nm) confirmed that the bright spots are indeed composed of Pd and Ce with the correct, initial weight ratio (FIG. 3C). By analyzing more than 50 single spots, both Pd and Ce were found to be associated in 49 of 50 spot analysis, thus demonstrating that the core-shell structures are intact and do not segregate after the deposition and calcination to 850° C. One spot showed the presence of only CeO₂ (spot 3 of FIG. 3C); a small concentration of CeO₂ nanoparticles may have been produced in the initial synthesis or excess ceria on the Pd@CeO₂ particles may have been removed during the calcination of the supported catalyst to 850° C. After the calcination at 500° C., EDS line profiles clearly evidenced single Pd@CeO₂ structures showing that the Pd signal arose from the core (FIG. 3E); high-resolution electron microscopy (HREM) (FIG. 3F) further confirmed a core-shell structure. White boxes in FIG. 3F highlight a single Pd@CeO₂ particle and selected digital diffraction patterns (DDP) demonstrate the presence of Pd in the core and of ceria in the outer layer. CeO₂ crystallites were ˜3 nm in size, in complete agreement with line broadening of the powder x-ray diffraction (XRD) lines (FIG. 22). These small Pd crystallites were maintained even after calcination at 850° C., and this stabilization was almost certainly a result of the core-shell configuration, where the organization of the crystallites around the preformed Pd particles avoids their agglomeration. In any case, Pd was always associated with a surrounding CeO₂ layer, so that there was no indication for the Pd@CeO₂ particles decomposing. Furthermore, although the CeO₂ shell is porous, the results suggest that intimate contact between the components can reduce the occurrence of Ostwald ripening (see also below).

A model was made of the Pd@CeO₂ units that are present on our support. The structure, which is formed by a central Pd nanoparticle (about 1.8 nm in diameter) surrounded by eleven CeO₂ nanocrystals, has the expected final weight ratios (1 and 9% respectively). In some orientations, the Pd nanoparticle is completely hidden by the surrounding ceria nanocrystals, demonstrating the difficulty in the imaging of these structures when using microscopy techniques. The microscopy data taken together provide conclusive evidence that the core-shell structure of the single Pd@CeO₂ units remain intact and show that these structures possess a high thermal stability upon deposition on the hydrophobic alumina.

### Example 10. Pd@CeO₂/H-Al₂O₃Catalytic Tests

Preparation of Pd(1%)/CeO₂ (9%)/Al₂O₃-IMP Reference Sample

Pd(NO₃)₂ and (NH₄)₂ Ce(NO₃)₆ were co-dissolved into 30 mL of water, pristine Al₂O₃ was added and the mixture stirred overnight. Solvent was then removed under vacuum and the powder dried at 120° C. overnight, ground to a particle size below 150 μm and calcined in air at 850° C. for 5 hours using a heating ramp of 3° C. min⁻¹.

Preparation of Pd(1%)*CeO₂ Reference Sample

Pd@CeO₂ structures were recovered by evaporation of the solvent, dried at 120° C. overnight, ground to a particle size below 150 μm and calcined in air at 850° C. for 5 hours using a heating ramp of 3° C. min⁻¹.

Preparation of Pd(1%)/CeO₂ (9%)/H—Al₂O₃ Reference Sample

Hydrophobic alumina was dispersed in 15 mL of THF and the appropriate amount of cerium(IV) tetrakis(decyloxide) added to the mixture. Although a complete adsorption occurred almost immediately, the mixture was left stirring overnight. The solid residue was recovered by centrifugation (4500 rpm for 15 minutes) and washed twice with THF. Finally, the powder was dried at 120° C. overnight, ground to a particle size below 150 μm and calcined in air at 500° C. for 5 hours using a heating ramp of 3° C. min⁻¹.

The CeO₂/H-Al₂O₃ material obtained was then dispersed again in 15 mL of THF and the appropriate amount of MUA-Pd nanoparticles added to the mixture. Although a complete adsorption occurred almost immediately, the mixture was left stirring overnight. The solid residue was recovered by centrifugation (4500 rpm for 15 minutes) and washed twice with THF. Finally, the powder was dried at 120° C. overnight, ground to a particle size below 150 μm and calcined in air at 850° C. for 5 hours using a heating ramp of 3° C. min⁻¹.

### Catalytic Tests and Characterization Techniques

All the experiments were conducted at atmospheric pressure. Methane oxidation experiments were performed in a U-shaped quartz microreactor with an internal diameter of 4 mm. The catalyst (˜25 mg) was sieved below 150 μm of grain size and loaded into the reactor to give a bed length of about 0.5 cm, between two layers of granular quartz, used both for preventing displacement of the catalyst powder and pre-heating the reagents. The reactor was heated by a Micromeritics Eurotherm 847 oven and the temperature of the catalyst was measured with a K-type thermocouple inserted inside the reactor and touching the catalytic bed. No appreciable conversions were found when only quartz or the bare supports (ceria and alumina) were placed in the reactor, in the range of temperatures used for kinetics experiments.

The reactant mixture composition was controlled by varying the flow rates of CH₄, O₂ and Ar while the total flow rate was kept constant at 83.3 mL min⁻¹. The conditions corresponded to Gas Hourly Space Velocity of 200,000 mL g⁻¹ h⁻¹. Typical conversions of the limiting reagent were always kept well below 5%, and most of the times below 2%, so that differential conditions could be assumed. The operating pressure was 1 atm, and the pressure drop (<0.02 atm) was neglected.

The composition of the effluent gases was monitored on-line using a quadrupole Mass Spectrometer (MS) (Hiden Analytical HPR20) equipped with a Secondary Electron Multiplier (SEM) detector. This detector was used to follow the parent molecular ions for CH₄ (16 amu), H₂O (18 amu), O₂ (32 amu) and CO₂ (44 amu).

Prior to measuring rates, each catalyst was cleaned under a flow of O₂ (5%)/Ar at 40 mL min⁻¹ for 30 minutes at 250° C., after heating from room temperature at 10° C. min⁻¹. Then, the reactant mixture was introduced and the catalyst aged in the reaction atmosphere at 850° C. for 1 h, after heating at 10° C. min⁻¹. Kinetic experiments were then performed

To record light-off curves, the catalyst was aged in the reaction atmosphere at 850° C. for 1 h, after heating at 10° C. min⁻¹, cooled down to 250° C. at the same rate, hold for 10 minutes, and a second ramp was used to measure the light-off curve up to 850° C., hold for 10 minutes, and cooled-down to 250° C. (heating and cooling ramps at 10° C. min⁻¹ unless otherwise noted).

Temperature Programmed Oxidation (TPO) experiments were conducted on the samples calcined to 850° C. The catalyst powder (˜25 mg) was placed in a U-shaped quartz reactor and exposed to a mixture of O₂ (1%) in Ar at 60 mL min⁻¹. The temperature was then raised to 1000° C. at 10° C. min⁻¹ and cooled down using the same rate. Oxygen release-uptake was evaluated using a quadrupole Mass Spectrometer (MS) (Hiden Analytical HPR20) equipped with a Secondary Electron Multiplier (SEM) detector.

N₂ physisorption and CO chemisorption experiments were carried out on a Micromeritics ASAP 2020C. The samples were first degassed in vacuum at 350° C. overnight prior to N₂ adsorption at liquid nitrogen temperature. For CO chemisorption, the samples were placed in a U-shaped quartz reactor, heated in flowing 5% O₂-95% Ar at 400° C. for 1 h, reduced in flowing 5% H₂-95% Ar at 150° C. for 1 h, and then evacuated at 150° C. for 1 h. CO adsorption experiments were conducted at ˜90° C. by means of a solid-liquid acetone bath and in the pressure range from 2 to 20 ton. Adsorption values were obtained by linear extrapolation to zero pressure.

Results and Discussion

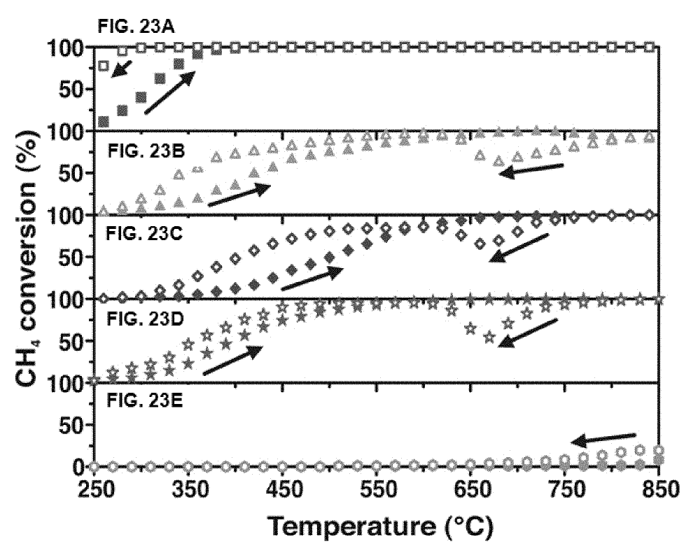

The Pd@CeO₂/H-Al₂O₃ catalysts were tested for the combustion of CH₄ (CH₄+2O₂→CO₂+2H₂O). To compare the effect of the nanostructure on the catalytic activity, additional reference samples were prepared using conventional synthetic procedures. The first reference catalyst consisted of 1-wt % Pd on a CeO₂ support, prepared by optimized incipient wetness impregnation (denoted as Pd/CeO₂—IWI). A second reference sample was prepared by impregnation of Pd (at 1 wt. %) and CeO₂ (at 9 wt %) from their nitrate salts onto pristine alumina (denoted as Pd/CeO₂/Al₂O₃-IMP). These and two additional reference samples are described in the FIG. 23. All of the catalysts were calcined at 850° C. for 5 hours and tested under the same reaction conditions.

CO chemisorption experiments confirmed the accessibility of the Pd phase in all the catalysts (Table 3). The thermal stability of the Pd@CeO₂/H-Al₂O₃ catalyst against sintering was confirmed by the average Pd particle size after calcination at 850° C. (2.2 nm) being very close to that of the initial starting Pd nanoparticles. The Pd/CeO₂/Al₂O₃-IMP sample demonstrated poor thermal stability and had an average Pd particle size of 6.0 nm after calcination. The Pd/CeO₂—IWI sample exhibited a small average particle size (1.9 nm), in accordance with previous reports for materials obtained using similar preparation methods. The Pd@CeO₂/H-Al₂O₃ catalysts prepared with different loadings of the structures (Pd/Ce weight ratio was kept at 1/9) showed similar metal dispersions as measured by CO chemisorption (Table 3), in accordance with the molecular nature of the Pd@CeO₂ units.

TABLE 3
CO chemisorption data for the Pd@CeO₂/H—Al₂O₃ core-shell catalyst,
Pd/CeO₂-IWI, Pd/CeO₂/Al₂O₃-IMP, Pd/CeO₂/H—Al₂O₃ and Pd@CeO₂
samples calcined to 850° C. for 5 hours and for the Pd@CeO₂/H—Al₂O₃
sample after reaction at 850° C. (denoted as Aged).

| Sample | D (%)^{a} | S(m² g⁻¹)^{b} | D (nm)^{c} |
|---|---|---|---|
| Pd(1%)@CeO₂(9%)/H—Al₂O₃ | 50 | 2.21 | 2.2 |
| Pd(1%)/CeO₂ IWI | 60 | 2.70 | 1.9 |
| Pd(1%)/CeO₂(9%)/Al₂O₃ IMP | 19 | 0.84 | 6.0 |
| Pd(1%)/CeO₂(9%)/H—Al₂O₃ | 56 | 2.54 | 2.0 |
| Pd(1%)@CeO₂ | <5 | — | — |
| Pd(0.25%)@CeO₂(2.25%)/H—Al₂O₃ | 43 | 0.48 | 2.6 |
| Pd(0.50%)@CeO₂(4.50%)/H—Al₂O₃ | 52 | 1.16 | 2.2 |
| Pd(0.75%)@CeO₂(6.75%)/H—Al₂O₃ | 47 | 1.58 | 2.4 |
| Pd(1%)@CeO₂(9%)/H—Al₂O₃-Aged | 39 | 1.72 | 2.8 |

^{a}Average metal accessibilty
^{b}Exposed metallic surface area per gram of catalyst
^{c}Average diameter calculated assuming a spherical particle shape

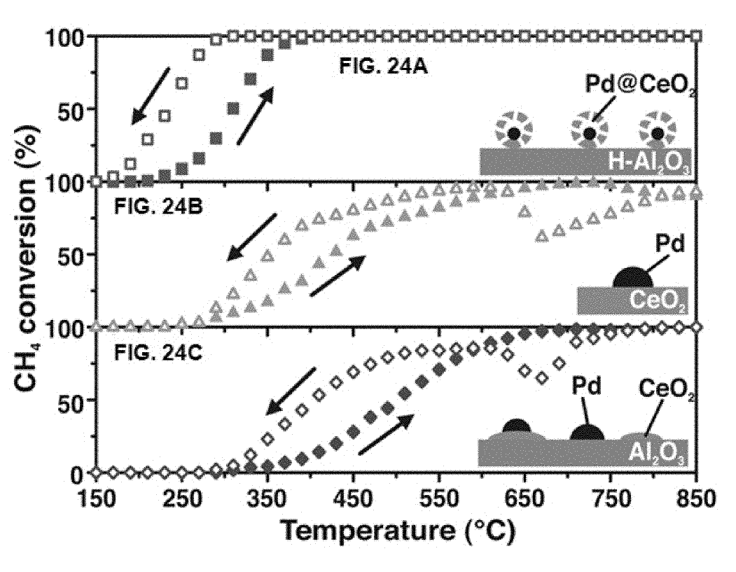

The Pd@CeO₂/H-Al₂O₃ material demonstrated outstanding catalytic performance. 100% conversion of CH₄ was observed for a gas stream of 0.5 vol. % CH₄ and 2.0 vol. % O₂ in Ar at a space velocity of 200,000 mL g⁻¹ h⁻¹ at about 400° C. (FIG. 24). By comparison, all the other reference samples achieved complete CH₄ conversion only above 700° C. (FIG. 23), more than 300 degrees higher than that found with the Pd@CeO₂/H-Al₂O₃ catalyst. Even when compared to state-of-the-art Pd/CeO₂ systems under the same reaction conditions, the temperature of complete conversion is decreased by more than 130° C. The enhanced reactivity of the Pd@CeO₂/H-Al₂O₃ catalyst is almost certainly the result of the strong Pd—CeO₂ interaction of the core-shell Pd@CeO₂ units. These interactions are not as optimal in the Pd/CeO₂—IWI catalyst, whereas some Pd could not be even in contact with CeO₂ in the Pd/CeO₂/Al₂O₃-IMP sample, resulting in lower activities when compared to the Pd@CeO₂/H-Al₂O₃ catalyst.

PdOₓ is commonly recognized as the active phase for this reaction. In the 650-850° C. temperature range, PdO decomposes to the thermodynamically stable Pd metal, which is much less active. The formation of metallic Pd decreases the rates for CH₄ combustion and is commonly observed as a transient decrease in the CH₄ conversion in light-off curves for both supported and unsupported Pd-based systems. The nature of the support can modify this behavior, and the presence of CeO₂ can shift the temperature window in which this transition occurs, provided that there is good contact between Pd and ceria. Pd@CeO₂/H-Al₂O₃ showed a stable activity for CH₄ oxidation over the entire range of temperatures studied (250-850° C.) (FIG. 24A), with no decrease in activity during either heating or cooling curves. By contrast, the reference samples clearly show the usual transient decrease in CH₄ conversion, both during the heating and the cooling portions of the curves at temperatures between 600 and 750° C., in agreement with previous reports. To the best of our knowledge, such strong inhibition of the of the dip deactivation in the conversion curve in Pd-based catalysts for catalytic CH₄ oxidation has not been observed previously, a result that again points to a special role of the CeO₂ in the core-shell configuration in stabilizing the active phase of the catalyst. The maximized metal-support interface area and the well know oxygen donation capability of CeO₂ can favor the oxidation of Pd nanoparticles, sustaining the catalytic reaction in the entire range of investigated temperatures.

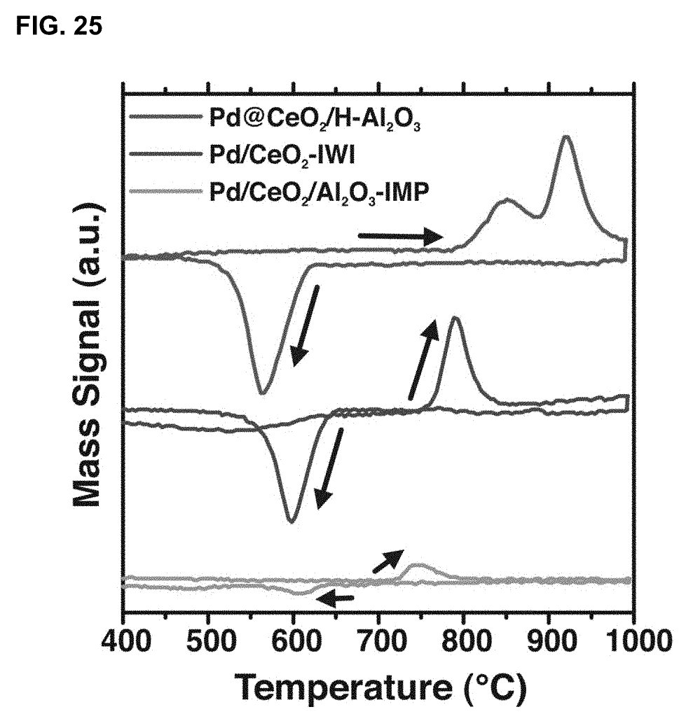

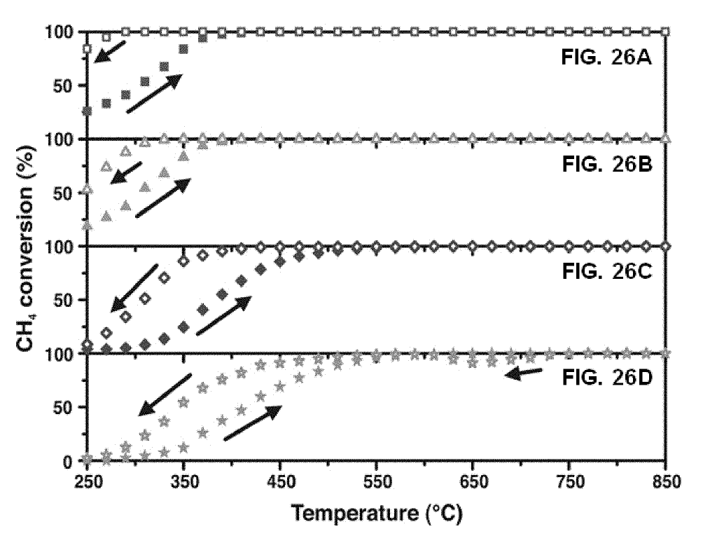

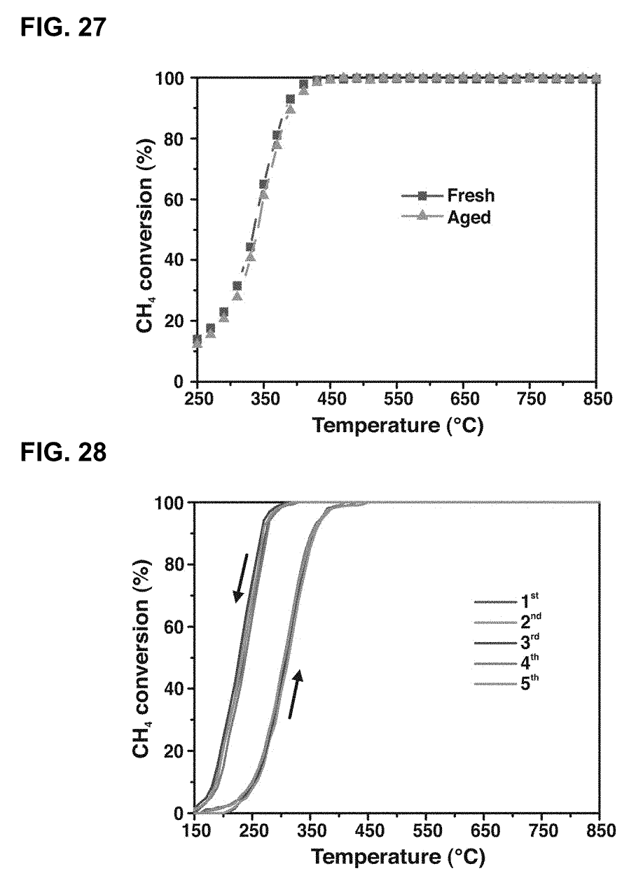

To gain further insights, temperature programmed oxidation (TPO) experiments were conducted on the three samples (FIG. 25). While a PdO—Pd transition is observed in each of the samples, this transition is shifted to higher temperatures on the Pd@CeO₂/H-Al₂O₃ sample. Also, there is a direct relationship between the amount of oxygen released in the upward temperature ramp and taken up in the cooling ramp and the sample activity. This is a clear indication that transformation of metallic Pd into PdOₓ is maximized in the supramolecular catalyst due to the close contact of ceria with Pd, explaining the much improved activity of Pd@CeO₂/H—Al₂O₃. Indeed, there was only a very small decrease in activity for the Pd@CeO₂/H-Al₂O₃ sample during cooling, even under extremely demanding reaction conditions (GHSV of ˜1,000,000 mL g⁻¹ h⁻¹) (FIG. 26). Furthermore, the Pd@CeO₂/H-Al₂O₃ was stable to aging treatments at 850° C. for 12 hours (FIG. 27) and after subsequent run-up and cool-down experiments (FIG. 28). CO chemisorptions results on the Pd@CeO₂/H-Al₂O₃ sample, performed after catalytic tests, showed minimal evidence for Pd sintering and no evidence for redispersion of PdO, ruling out the contribution of this effect to the observed high, stable activity (Table 3).

There are a number of possible explanations for why the ceria shell has such a dramatic effect in maintaining an oxidized Pd core. Without being bound by any particular theory, the thin ceria shell could well be under mechanical stress due to spatial confinement of individual Pd@CeO₂ units. Stress can positively affect the oxygen mobility. Without being bound by any particular theory, the small CeO₂ crystallite size that is maintained due to the templating effect of the Pd cores likely leads to a high degree of disorder within the ceria shell, breaking the typical fluorite structure that stabilizes Ce⁴⁺, increasing the reducibility of the ceria shell. Without being bound by any particular theory, the decoration of the Pd by ceria is not complete, as demonstrated by the fact that there is still significant adsorption of CO. This could lead to the formation of a high concentration of undercoordinated, reactive Pd sites at the interface between the metal and the oxide that are known to be more effective in CH₄ activation.

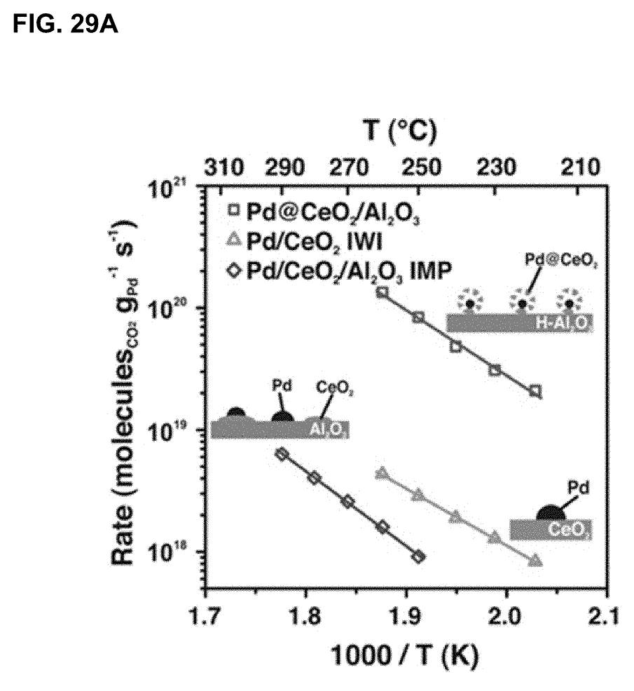

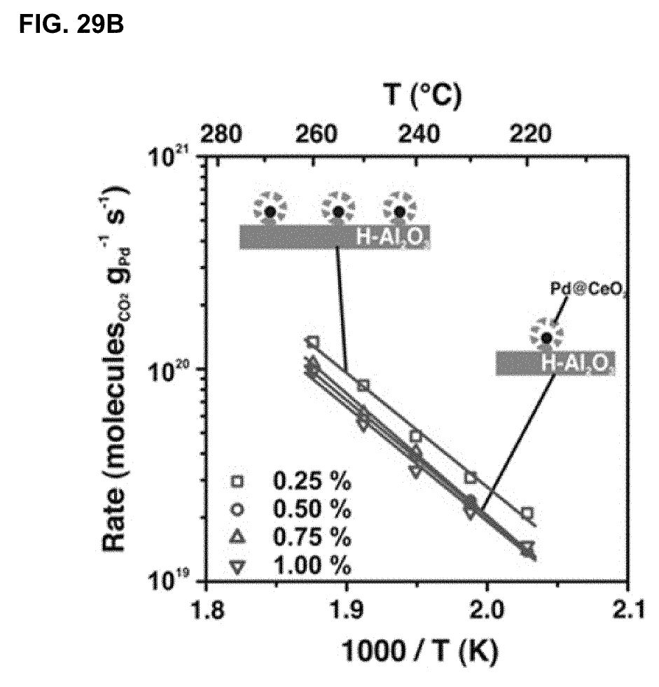

Kinetic rate data further corroborate the very high intrinsic activity of the supramolecular catalyst when compared to the reference catalysts (FIG. 29).

The reaction rates on the Pd@CeO₂/H-Al₂O₃ sample were about 40 times higher than those on Pd/CeO₂—IWI and 200 times higher than on Pd/CeO₂/Al₂O₃-IMP, respectively, under the same experimental conditions (FIG. 29A). Furthermore, the rates were more than one order of magnitude higher than that of other optimized Pd-based catalysts. CO adsorption data (Table 3) demonstrated that the difference in activity cannot be related to the amount of exposed Pd because the Pd/CeO₂—IWI sample showed a higher Pd accessibility than that of the Pd@CeO₂/H-Al₂O₃ core-shell catalyst (60% vs 50%, respectively). The apparent activation energies for each of the catalysts were also similar (90-120 kJ mol⁻¹) and slightly lower than literature data, but implying that the nature of the active sites in Pd@CeO₂/H-Al₂O₃ are similar to that of the other two catalysts. Notably, the number of active sites was dramatically increased in Pd@CeO₂/H-Al₂O₃ sample by means of the special configuration, as evidenced by the larger pre-exponential factor and TOF values (Table 4).

TABLE 4
Kinetic data for CH₄ combustion for Pd@CeO₂/H—Al₂O₃
core-shell catalyst, Pd/CeO₂-IWI, Pd/CeO₂/Al₂O₃-IMP samples.
Conversions were kept similar for all the samples in order to
guarantee a similar effect of reactants and products to the systems.

| | Temperature | Eₐₜₜ | A | |
|---|---|---|---|---|
| | range | (kJ | (molecules | TOF |
| Sample | (° C.)^{a} | mol⁻¹)^{b} | g⁻¹ s⁻¹)^{c} | (s⁻¹)^{d} |
| Pd(1%)@CeO₂(9%)/ | 220-270 | 103 | 1.5 · 10²¹ | 47 · 10⁻³ |
| H—Al₂O₃ | | | | |
| Pd(1%)/CeO₂ IWI | 220-270 | 90 | 4.6 · 10¹⁹ | 1.3 · 10⁻³ |
| Pd(1%)/CeO₂(9%)/ | 250-290 | 120 | 7.5 · 10¹⁹ | 1.5 · 10⁻³ |
| Al₂O₃ IMP | | | | |

^{a}Range of temperatures used for the measurements.
^{b}Apparent activation energy.
^{c}Arrheius pre-exponential factor.
^{d}At 250° C., based on the exposed Pd atoms measured by CO chemisorption.

Furthermore, samples prepared at different Pd loadings (Pd/Ce weight ratio was kept at 1/9) showed very similar reaction rates when normalized by the amount of metal (FIG. 29B) and exhibited identical activation energies (100-110 kJ mol⁻¹). Overall, the presented data demonstrate that the Pd@CeO₂ structures deposited as single units on the hydrophobic alumina act as supramolecular catalysts. In these structures, the synergy between Pd and CeO₂ produces active sites that are equally active in all of the samples, though in different numbers. As a further confirmation, CO chemisorption results demonstrated very similar Pd accessibility for all of the Pd@CeO₂ samples prepared, corroborating the defined geometry and morphology obtained through the supramolecular approach. This approach could potentially be valuable even for three-way catalysts, where the special properties shown here could be important for improving the activity at low oxygen concentrations, for enhanced stability against sintering, and for protection against poisoning through the core-shell configuration.

1. A core-shell nanoparticulate composition comprising: a late-transition-metal core encapsulated by a metal oxide shell, said shell comprising CeO₂, HfO₂, TiO₂, ZnO, ZrO₂, or a combination thereof.

2. The composition of claim 1 wherein the late-transition-metal core comprises Pd or Pt.

3. A core-shell nanoparticulate composition, comprising: a late-transition-metal core encapsulated by a metal oxide shell comprising at least one oxide of a metal of Group 3, 4 or 5.

4. The composition of claim 3, wherein the late-transition-metal core contains no more than 50 wt % Pd relative to the weight of the entire core.

5. The composition of claim 3, wherein the late-transition-metal core comprises Pt or the metal oxide shell comprises CeO₂, HfO₂, TiO₂, ZrO₂, or a combination thereof.

6-7. (canceled)

8. A composition, comprising: a plurality of core-shell nanoparticles of the composition of claim 3, said nanoparticles displayed (i) on a metal oxide support, the core-shell nanoparticles comprising a Pt core encapsulated by a metal oxide shell; (ii) on a silica intermediate layer that is attached to a metal oxide support; or (iii) as a substantially single layer superposed on a metal oxide support.

9. The composition of claim 8 wherein the metal oxide shell comprises CeO₂, HfO₂, TiO₂, ZnO, ZrO₂, or a combination thereof.

10-17. (canceled)

18. The composition of claim 8, wherein the core-shell nanoparticles of (ii) are arranged in a substantially single layer.

19. A fuel cell comprising the composition of claim 8.

20. (canceled)

21. A method, comprising:
(a) reducing a Pt(II) salt in the presence of excess C₍₆₋₁₈₎-alkylamine with a lithium alkylborohydride to form an alkylamine-coated Pt metal nanoparticle;
(b) contacting the alkylamine-coated Pt metal nanoparticle with a linking compound having a formula:
HS—R¹—R²
where R¹ is 3 to 18 carbon atoms long and R² is a carboxylic acid or alcohol group;
to form a Pt metal nanoparticle coated with linking compound; and
(c) contacting the Pt metal nanoparticle coated with linking compound with at least one metal alkoxide to form metal alkoxide superposed on a Pt metal nanoparticle core; and
(d) optionally hydrolyzing the metal alkoxide superposed on the Pt metal nanoparticle core, optionally in the presence of C₍₆₋₁₈₎-alkylcarboxylic acid, to form a Pt metal core encapsulated by metal alkoxide shell; and
(e) after step (d), optionally calcining the Pt metal core encapsulated by metal oxide shell to form a Pt metal core encapsulated by metal oxide shell.

22. The method of claim 21, wherein the Pt(II) salt comprises potassium tetrachloroplatinate(II), the C₍₆₋₁₈₎-alkylamine comprising dodecylamine, the lithium alkylborohydride comprises lithium triethylborohydride, the metal alkoxide comprises a zirconium(IV) tetrakis(butoxide) or a titanium(IV) butoxide, and the linking compound comprises 11-mercaptoundecanoic acid.

23-25. (canceled)

26. A method, comprising:
(a) contacting a hydrophilic metal oxide support with an organosilane to form a hydrophobic metal oxide support; and
(b) contacting the hydrophobic metal oxide support with a plurality of core-shell nanoparticles, each nanoparticle comprising a late-transition-metal core encapsulated by a shell comprising metal alkoxide;
(a) and (b) being performed so to form a structure comprising plurality of core-shell nanoparticles displayed on a siloxane intermediate layer that is attached to a metal oxide support; and
(c) optionally calcining the structure comprising the plurality of core-shell nanoparticles displayed on a siloxane intermediate layer to form a plurality of core-shell nanoparticles comprising late-transition-metal core encapsulated by metal oxide shell displayed on a silica layer that is attached to a metal oxide support.

27. (canceled)

28. The method of claim 26 wherein the organosilane comprises triethoxy(octyl)silane, the late-transition-metal core comprises Pd, or the metal oxide shell comprises CeO₂.

29. (canceled)

30. A method for catalyzing a water-gas shift reaction, comprising: contacting H₂O and CO with a plurality of core-shell nanoparticles, each core-shell nanoparticle comprising a late-transition-metal core encapsulated by a metal oxide shell and displayed (i) on a silica intermediate layer that is attached to a metal oxide support or (ii) as a substantially single layer superposed on metal oxide support, under conditions sufficient to form H₂ and CO₂.

31. (canceled)

32. The method of claim 30, wherein the late-transition metal core comprises Pd and the metal oxide shell comprises CeO₂.

33. (canceled)

34. A method for catalyzing a methanol reforming reaction, comprising: contacting H₂O and CH₃OH with a plurality of core-shell nanoparticles, said core-shell nanoparticles each comprising a late-transition-metal core encapsulated by a metal oxide shell, the plurality of core-shell nanoparticles being displayed (i) on a silica intermediate layer that is attached to a metal oxide support or (ii) as a substantially single layer superposed on metal oxide support.

35. (canceled)

36. The method of claim 34, wherein the late-transition metal core comprises Pd and the metal oxide shell comprises CeO₂.

37. (canceled)

38. A method for catalyzing the combustion of a hydrocarbon,
comprising: contacting said hydrocarbon with a plurality of core-shell nanoparticles in the presence of O₂, each nanoparticle comprising a late-transition-metal core encapsulated by a metal oxide shell, said plurality of core-shell nanoparticles displayed (i) on a silica intermediate layer that is attached to a metal oxide support or (ii) as a substantially single layer superposed on metal oxide support.

39. (canceled)

40. The method of claim 38, wherein the hydrocarbon comprises methane.

41. (canceled)

42. The method of claim 38, wherein the late-transition metal core comprises Pd and the metal oxide shell comprises CeO₂.

43. (canceled)
